(19) United States
(12) Patent Application Publication
(10) Pub. No.: US 2013/0325839 A1
(43) Pub. Date: Dec. 5, 2013

(54) Single Search Box Global

(71) Applicant: TeleCommunication Communication Systems, Inc., Annapolis, MD (US)

(72) Inventors: Mark Goddard, Rancho Santa Margarita, CA (US); Brant Clark, Mt. Baldy, CA (US); Diego Kaplan, San Diego, CA (US); Naresh Kumar Ganapathy, Aliso Viejo, CA (US); Ivan Yang, Trabuco Canyon, CA (US)

(21) Appl. No.: 13/887,827

(22) Filed: May 6, 2013

Related U.S. Application Data
(63) Continuation-in-part of application No. 13/783,732, filed on Mar. 4, 2013.
(60) Provisional application No. 61/606,718, filed on Mar. 5, 2012.
(60) Provisional application No. 61/727,485, filed on Nov. 16, 2012.

(51) Int. Cl. G06F 17/30

(52) U.S. Cl. CPC G06F 17/30867
USPC 707/708

(57) ABSTRACT

A global single search system that returns relevant search results for a user search query by identifying user intent and context implied therein. The system supports POI and address searches initiated from a single search box global only. Search query data is input in a single search box on a single search client to initiate a search for an arbitrary piece of data. Meta-data concerning a nature of a search is not provided to the single search system. A search servlet uses an ordered series of filter methods to extract specific aspects of user intent from a freeform search query, and accumulate intent information within a context shared by all filters. The system determines a data corpus to search based on context provided in a user search query. Relevant search results are returned to the single search client in a search response. The global single search system supports global markets.

The present invention is a continuation-in-part of U.S. application Ser. No. 13/783,732, filed Mar. 4, 2013, entitled “Filtered Search Query Data for Context and User Intent Within a Location-Based Search Engine”; which in turn claims priority from U.S. Provisional No. 61/606,718, filed Mar. 5, 2012, entitled “Filtered Search Query Data for Context and User Intent within a Location-Based Search Engine”, and from U.S. Provisional No. 61/727,485, filed Nov. 16, 2012, entitled “Single Search Box Global”, the entirety of all of which are expressly incorporated herein by reference.

### BACKGROUND OF THE INVENTION

1. Field of the Invention

This invention relates generally to communications. More particularly, it relates to location-based services and local searching including address.

2. Background of the Related Art

Conventional location-based services (e.g. maps.google.com and navteq.com) typically support one or more text input fields (i.e. search boxes) within which a user may input a search query to initiate a search for a point of interest (P01), address, etc. Some conventional location-based services search for matches to a search query across one specific data corpus, wherein that one specific data corpus is selected based on non-natural syntax/keywords embedded in the search query. Moreover, other conventional location-based services search for matches to a search query across all available data corpuses, on a blind term for term basis.

Unfortunately, when all terms embedded in a user search query are searched against all data corpuses, a results set is unlikely to be returned within an acceptable threshold of time. Moreover, blind searches performed against all data corpuses occasionally return results from more than one corpus which must be ordered in some arbitrary manner (most notably not in order of relevance against a single reference) before they can be returned to a user.

Searching query data across multiple independent data sources often fails to result in a determination of a location reference. For instance, searching user search query, “pizza Chicago Illinois”, for matches across multiple corpuses, likely returns an abundance of false positives, being that many pizza restaurants have the term ‘Chicago’ embedded in their place name. An over abundance of false positives returned in a results set is likely to overwhelm good matches returned therewith.

### SUMMARY OF THE INVENTION

A method and apparatus for filtering search query data for context and user intent within a location-based search engine, comprises a global single search system. The single search system generates and returns relevant search results for a user search query by identifying user intent and context implied therein. In accordance with the principles of the present invention, the single search system returns relevant search results for a user search query, even in the absence of accompanying meta-data, e.g., meta-data identifying a search query as a POI query, an address query, etc. The present invention pertains to POI and address searches initiated from a single search box global.

In accordance with the principles of the present invention, the global single search system supports numerous data sets, numerous languages, and multiple character sets to enable single search on a global scale. The global single search system determines a particular set of data to search when there are multiple data corpuses to choose from, based specifically upon context provided in a user search query.

In accordance with the principles of the present invention, the global single search system uses an ordered series of filter methods to progressively extract specific aspects of user intent from a freeform search query, and to accumulate intent information within a context shared by all filters.

User search query data is input into a single search box global on a single search client (i.e. a client application) to initiate a single search for an arbitrary piece of data (provided that arbitrary piece of data is maintained in a data set supported by the global single search system). Meta-data concerning the nature of a search is not provided to the global single search system.

In accordance with the principles of the present invention, single search functionality is provided to the single search client via a search servlet on a single search server. In particular, the single search client sends a search query to the single search server to request relevant search results for each single search initiated thereon. Search queries received on the single search server are forwarded to the search servlet. The search servlet then retrieves and returns relevant search results to the single search client for each search query received thereon.

In accordance with the principles of the present invention, the global single search system additionally supports advanced suggestion capabilities. In particular, suggestions are displayed on the single search client as a search query is input, character by character, into the single search box global. Selection of a suggestion initiates a single search on that suggestion item.

In accordance with the principles of the present invention, the global single search system additionally supports existing premium placement ad functionality. In particular, the single search server returns a premium placement ad with each set of local search results returned to the single search client. The global single search system uses an existing integrated logistics analysis program to track and store impressions and interactions of users with premium placement ads.

### BRIEF DESCRIPTION OF THE DRAWINGS

Features and advantages of the present invention become apparent to those skilled in the art from the following description with reference to the drawings:

FIG. 1 depicts an exemplary single search box global available on a main application screen of a single search client, in accordance with the principles of the present invention.

FIG. 2 depicts an exemplary single search box global available on a map screen of a single search client, in accordance with the principles of the present invention.

FIG. 3 depicts an exemplary single search box global available on an enter an address screen of a single search client, in accordance with the principles of the present invention.

FIG. 4 depicts an exemplary single search box global available on a find a place screen of a single search client, in accordance with the principles of the present invention.

FIG. 5 depicts an exemplary network structure used to provide single search functionality, in accordance with the principles of the present invention.

FIG. 6 illustrates exemplary single search support provided by a search servlet on a single search server, in accordance with the principles of the present invention.

FIG. 7 depicts an exemplary display of search results on a single search client, in accordance with the principles of the present invention.

FIG. 8 depicts exemplary display of suggestions on a single search client, in accordance with the principles of the present invention.

FIG. 9 portrays exemplary display of recent searches on a single search client, in accordance with the principles of the present invention.

FIG. 10 depicts a user interface flow that demonstrates an exemplary single search behavior, in accordance with the principles of the present invention

FIG. 11 shows an exemplary call flow demonstrating a search query and a search reply for a local search, in accordance with the principles of the present invention.

FIG. 12 depicts an exemplary flow diagram for identifying location references in input text, in accordance with the principles of the present invention.

FIG. 13 shows an exemplary call flow demonstrating a search query and a search reply for suggestions, in accordance with the principles of the present invention.

FIG. 14 portrays an exemplary call flow demonstrating a search query and a search reply for a selected POI suggestion, in accordance with the principles of the present invention.

FIG. 15 depicts an exemplary context filtering sequence, in accordance with the principles of the present invention.

FIG. 16 depicts an exemplary logic flow for accepting city, state, zip (CSZ) lookup module results, in accordance with the principles of the present invention.

FIG. 17 depicts an exemplary flow diagram for identifying location references in a search query, in accordance with the principles of the present invention.

FIG. 18 depicts exemplary behavior of search results on the single search client, in accordance with the principles of the present invention.

FIG. 19 depicts an exemplary find a place results screen, in accordance with the principles of the present invention.

FIG. 20 depicts an exemplary enter an address results screen, in accordance with the principles of the present invention.

FIG. 21 portrays a call flow depicting an exemplary single search via automatic speech recognition (ASR), in accordance with the principles of the present invention.

FIG. 22 depicts an exemplary de-duplication mechanism used to remove duplicate POIs from source data, in accordance with the principles of the present invention.

### DETAILED DESCRIPTION OF ILLUSTRATIVE EMBODIMENTS

The present invention comprises a global single search system that expands the scope of a single search system disclosed in co-pending and co-owned U.S. patent application Ser. No. 13/783,732, filed Mar. 4, 2013, entitled: “FILTERED SEARCH QUERY DATA FOR CONTEXT AND USER INTENT WITHIN A LOCATION BASED SEARCH ENGINE”, claiming priority from U.S. Provisional Application No. 61/727,485, filed Mar. 5, 2012, entitled: “FILTERED SEARCH QUERY DATA FOR CONTEXT AND USER INTENT WITHIN A LOCATION BASED SEARCH ENGINE”, both of which are explicitly incorporated herein by reference. The single search system disclosed in U.S. Ser. No. 13/783,732 maintains US data only and only provides support for US markets. The global single search system expands the scope of the single search system disclosed in U.S. Ser. No. 13/788,732, to include support for global markets. The single search box global feature supports all existing requirements of the single search box feature, as disclosed in U.S. patent application Ser. No. 13/783,732.

In accordance with the principles of the present invention, the global single search system maintains data sets for multiple countries, to expand support to global markets. The global single search system additionally supports multiple character sets, multiple languages, and geocoding for foreign addresses.

The global single search system is compatible with current single search clients and does not change the client-server protocol of existing single search clients in any way. New parameters/elements disclosed herein are applied to the global single search system in a backwards compatible fashion.

The global single search system introduced herein generates and returns relevant search results for a user search query by identifying user intent and context implied therein. In accordance with the principles of the present invention, the global single search system returns relevant search results for a user search query, even in the absence of accompanying meta-data, e.g., meta-data identifying a search query as a POI query, an address query, etc. In particular, the global single search system permits users to search global POI and address data via a single search box global, without indicating a type of search, e.g. POI search, address search, etc. The present invention pertains to POI and address searches initiated from a single search box global only, and is preferably used in combination with location-based search engines.

In accordance with the principles of the present invention, the global single search system generates and returns relevant search results for a user search query by identifying user intent implied therein. User intent is identified by examining constituent parts of a user search query. In particular, the global single search system uses an ordered series of filter methods to progressively extract specific aspects of user intent from a freeform search query, and to accumulate intent information within a context shared by all filters.

For instance, given user search query, “pizza but Chicago Illinois”, the global single search system is able to determine that a requesting user is searching for a specific type of restaurant, ‘pizza hut’, and that the requesting user has provided a specific location reference, ‘Chicago, Illinois’, about which to search.

The global single search system maintains numerous data sets and supports multiple languages and multiples character sets to enable single search on a global scale. The global single search system determines which data corpus to search when there are multiple data corpuses to choose from, based specifically upon context provided in a user search query.

The global single search system does not require a search query to be uniquely identified as a POI search query or an address search query. Rather, the global single search system permits users to simply enter an arbitrary search string into a single search box global (i.e. text input field) to initiate a search.

The single search box global is a standalone text input field (i.e. not paired with a ‘where’ field) within which a user may input a search query (e.g. in one disclosed embodiment is not to exceed 255 characters, though any length input is within the principles of the invention) to initiate a single search for an arbitrary piece of data (provided that arbitrary piece of data is maintained in a data set supported by the global single search system). In accordance with the principles of the present invention, users access a single search box global via a single search client (i.e. a client application). More particularly, the single search box global is preferably available on a main application screen (i.e. a home screen, carousel view or map view), a map screen, an enter an address screen, and a find a place screen on the single search client.

In accordance with the principles of the present invention, the global single search system additionally supports advanced suggestion capabilities. In particular, the global single search system returns search suggestions as a user enters a search query in to the single search box global.

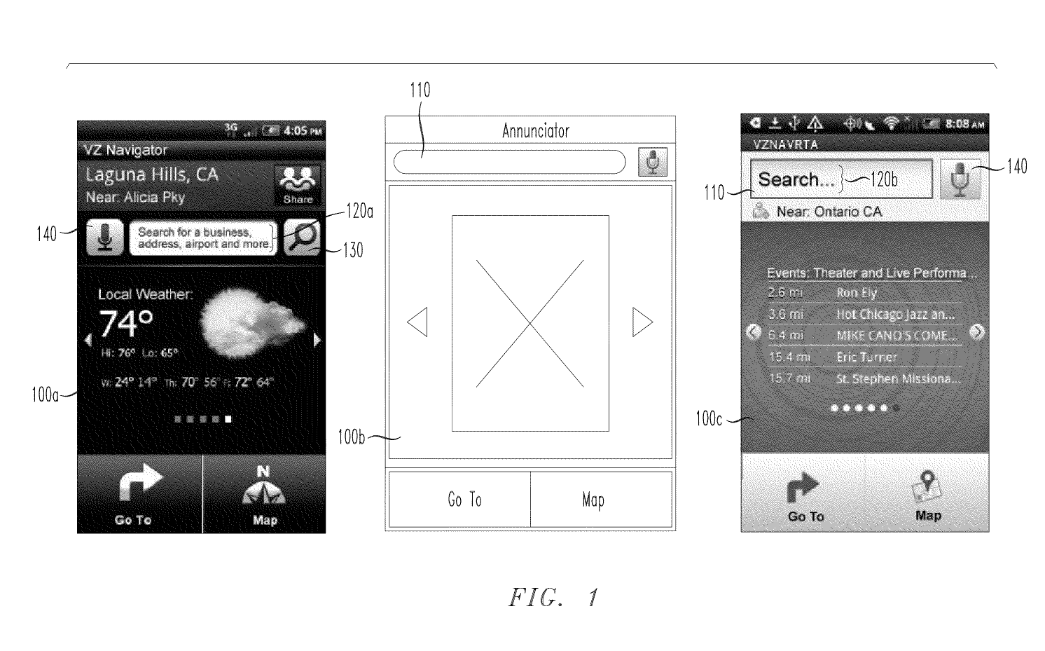

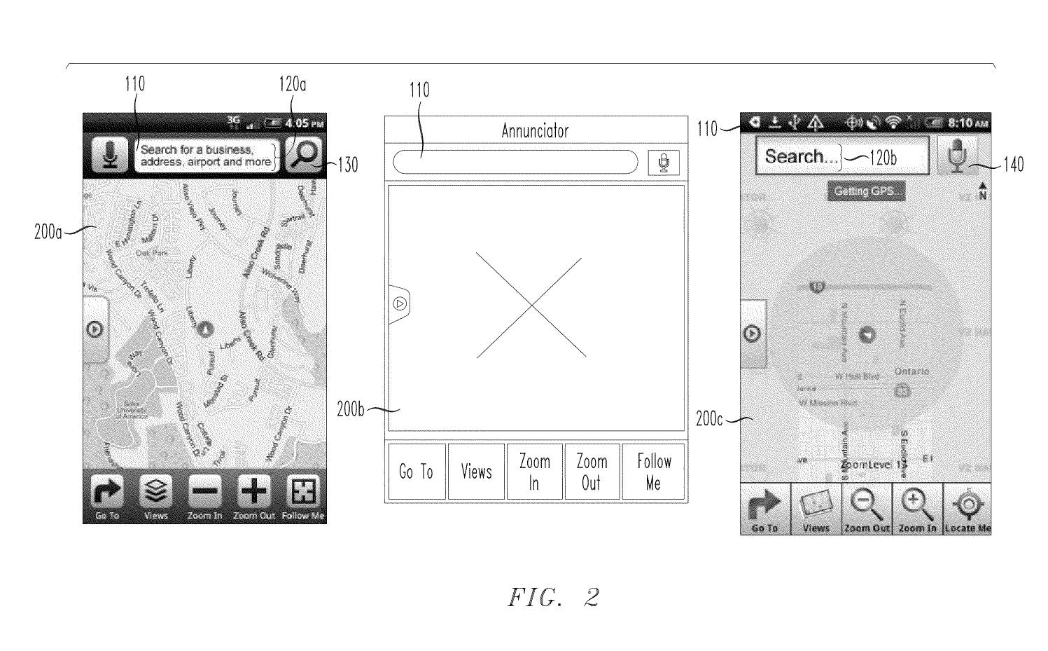

FIG. 1 depicts an exemplary single search box global available on a main application screen on a single search client, in accordance with the principles of the present invention.

In particular, FIG. 1 depicts three exemplary main application screens 100a-100c, each of which displays a single search box global 110.

As depicted in FIG. 1, a search button (i.e. a button that initiates a single search when pressed) 130 is preferably positioned next to the single search box global 110 and the single search box global 110 preferably comprises a helper text 120 e.g., ‘Search’ or ‘Search for a Business, Address, Airport, and More’, etc. An automatic speech recognition (ASR) button (i.e. a button to initiate a single search via ASR) 140 is also preferably positioned next to the single search box global, as depicted in FIG. 1.

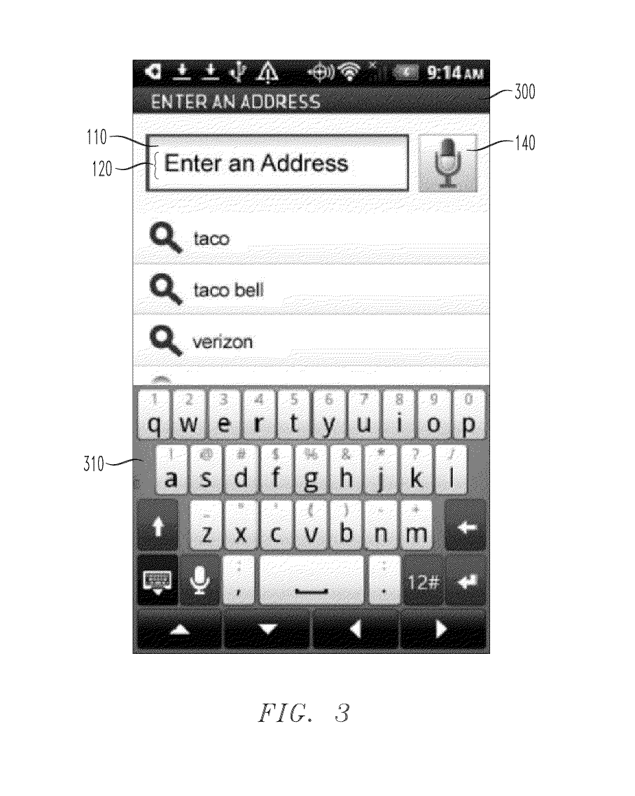

FIG. 2 depicts an exemplary single search box global available on a map screen on a single search client, in accordance with the principles of the present invention.

In particular, FIG. 2 depicts three exemplary map screens 200a-200c, each of which displays a single search box global 110.

FIG. 3 depicts an exemplary single search box global available on an enter an address screen on a single search client, in accordance with the principles of the present invention.

In particular, FIG. 3 depicts an exemplary single search box global 110 displayed on the enter an address screen 300 on the single search client. The enter an address screen 300 depicted in FIG. 3 additionally displays a keyboard 310. A keyboard 310 is presented on the single search client when focus (a cursor) is placed inside the single search box global 110. A helper text 120 on the enter an address screen 300 preferably reads, ‘Enter an Address’.

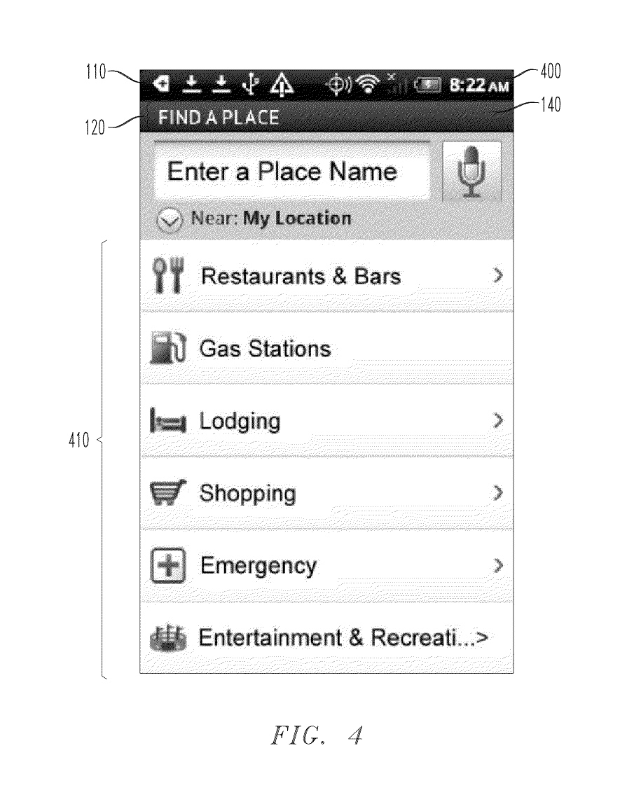

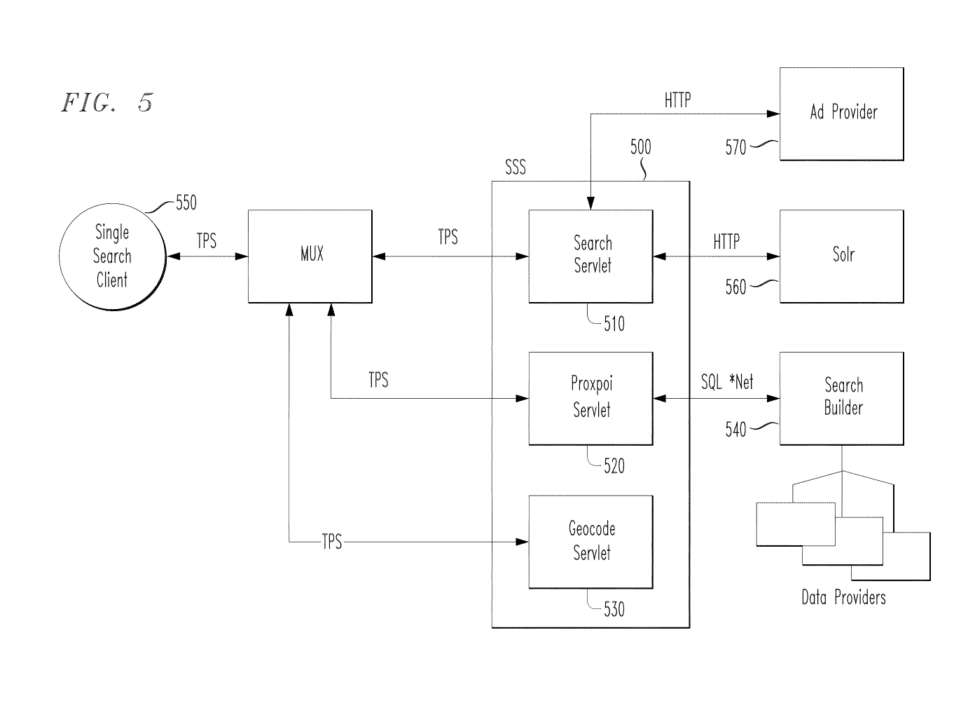

FIG. 4 depicts an exemplary single search box global available on a find a place screen on a single search client, in accordance with the principles of the present invention.

In particular, FIG. 4 depicts an exemplary single search box global 110 and an exemplary category list 410 displayed on the find a place screen 400 on the single search client. A helper text 120 on the find a place screen 400 preferably reads, ‘Enter a Place Name’.

Single search functionality is provided to the single search client via a search servlet on a single search server.

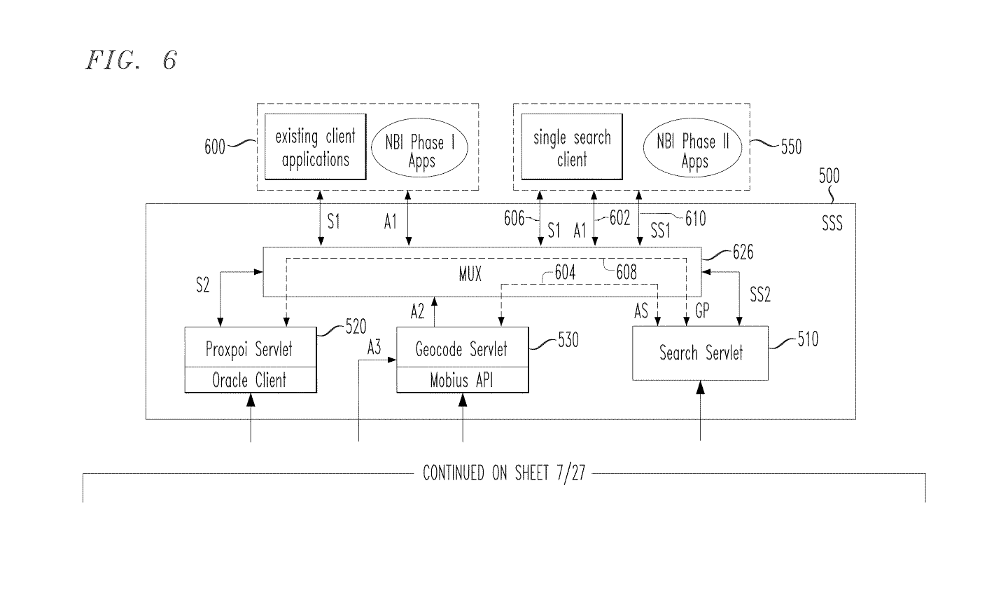

FIG. 5 depicts an exemplary network structure used to provide single search functionality, in accordance with the principles of the present invention.

In particular, the single search client 550 interacts with the single search server 500 to request search results for single searches initiated thereon.

As depicted in FIG. 5, a single search server 500 comprises a search servlet 510 (specific to user search queries), an existing proxpoi servlet 520 (interfacing with an existing SearchBuilder engine 540), and an existing geocode servlet 530. Single search results are handled by the search servlet 510 on the single search server 500.

To retrieve search results for a single search request, the search servlet 510 interfaces with an existing open source Apache Solr™ engine 560, as portrayed in FIG. 5. Apache Solr™ 560 (an Apache Foundation project) is a feature rich, scalable, and well-supported (through an active development company) standalone search platform that provides full text search, database integration, geospatial search, etc.

In accordance with the principles of the present invention, the search servlet 510 also returns advertisements in response to certain single search requests. To retrieve advertisements, the search servlet 510 interfaces with an ad provider 570 (e.g. xAd), as shown in FIG. 5.

The single search client 550 sends a search query to the single search server 500 for each single search initiated thereon. Search queries received on the single search server 500 are handled by the search servlet 510. In response to a search query, the search servlet 510 returns relevant search results to the single search client 550, whereupon results are subsequently displayed.

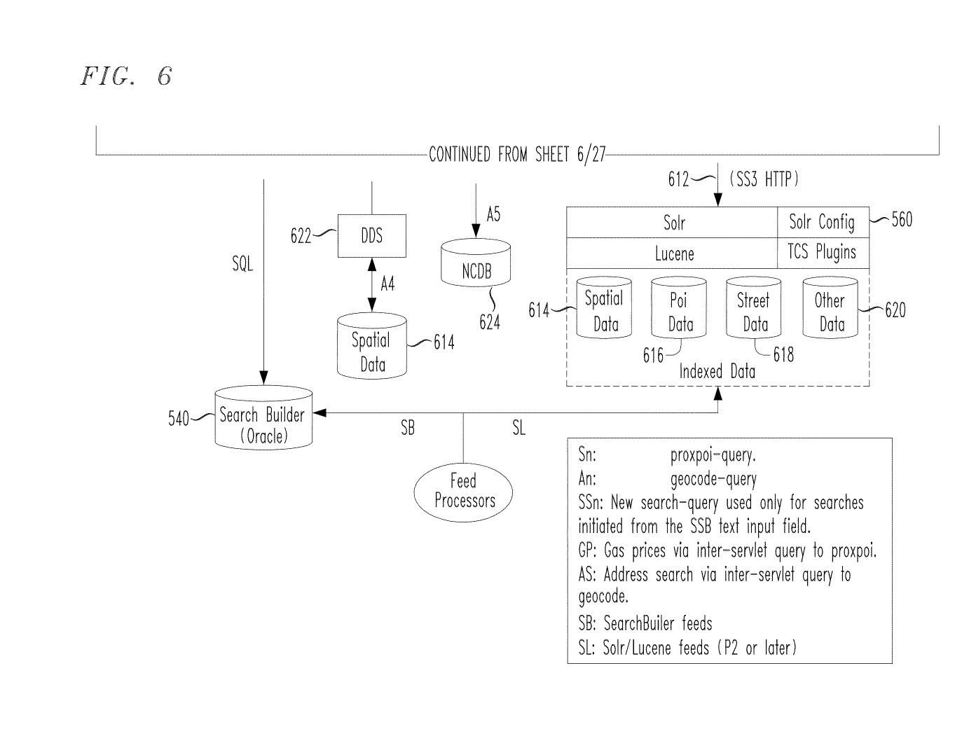

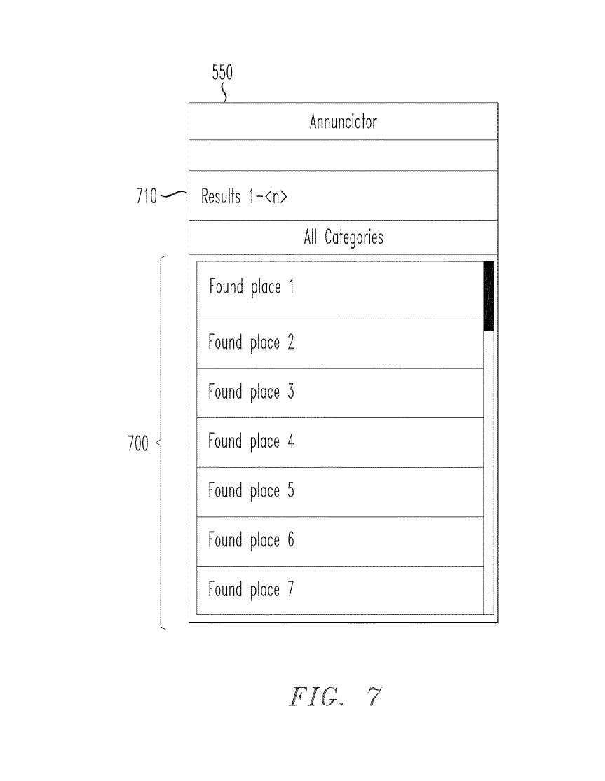

FIG. 6 illustrates exemplary single search support provided by a search servlet on a single search server, in accordance with the principles of the present invention.

As depicted in FIG. 6, single search functionality is provided to the single search client 550 via the search servlet 510, whereas existing client applications 600 are supported by an existing proxpoi servlet 520.

In particular, when a conventional address search query 602 is received on the single search server 500, a multiplexor 626 on the single search server 500 forwards the address search query to the search servlet 510. The search servlet then transmits an interservlet query 604 to the existing geocode servlet 530 (which accesses a map database, in this case the NAVBuilder Core Database (NCDB) 624 and a spatial data database 616) for appropriate geocode query results. Similarly, when a conventional gas price query 606 is received on the single search server 500, the multiplexor 626 on the single search server 500 forwards the gas price search query to the search servlet 510. The search servlet 510 then transmits an interservlet query 608 to the existing proxpoi servlet 520 (which is referencing searchbuilder 540) for appropriate gas price query results. The search servlet 510 returns geocode search results and gas price search results to the single search client 550, whereupon results are subsequently displayed.

Moreover, when a search query for a single search 610 is received on the single search server 500, the multiplexor 626 on the single search server 500 forwards the search query to the search servlet 510. The search servlet 510 then submits an HTTP single search query 612 to the existing Apache Solr™ engine 560 (which is preferably referencing a Apache Lucent™ search library 626) for relevant search results. In response, Apache Solr™ 560 returns relevant data (i.e. spatial data 614, POI data 616, street data 618 and/or any other relevant data 620) to the requesting search servlet 510. The search servlet 510 then returns a search response with relevant search results to the single search client 550, and results are subsequently displayed thereon.

A single search can take several forms and may be initiated in several ways. The present invention comprises several potential use cases.

For instance, in one potential use case, a search query is input in to the single search box global 110 and the search button 120 positioned next to the single search box global 110 (or an ‘enter’ key on a keyboard 310) is pressed. When a search is initiated via the search button 120 (or an ‘enter’ key), the single search client 550 sends a search query (comprising the user search query entered in to the single search box global 110) to the single search server 500 to request relevant search results. In response to the search query, the search servlet 510 generates and returns relevant search results to the single search client 550, whereupon results are subsequently displayed.

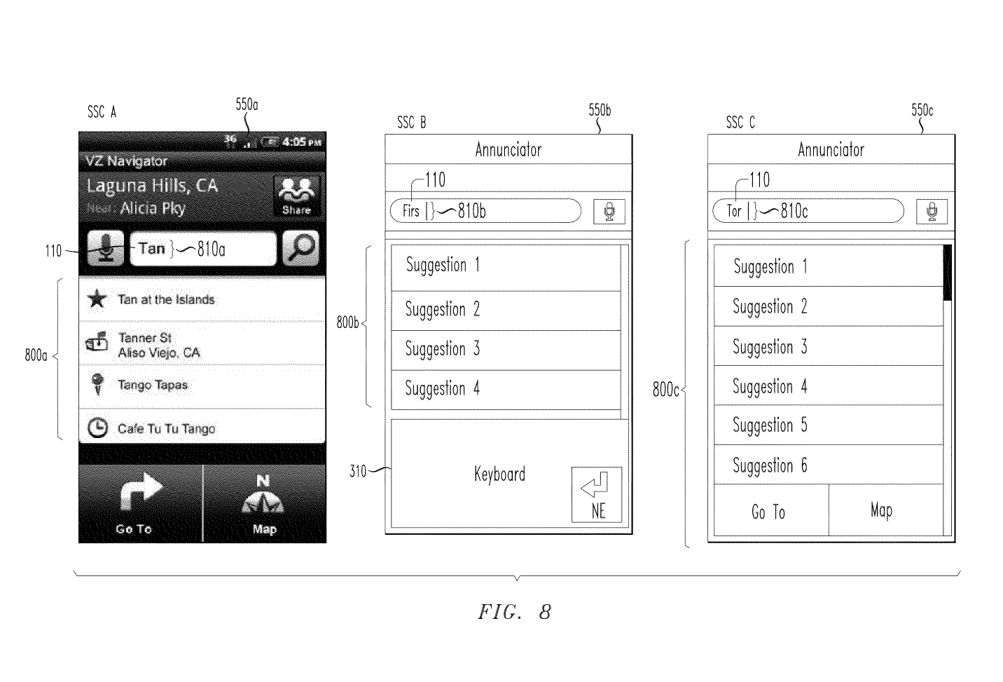

FIG. 7 depicts an exemplary display of search results on a single search client, in accordance with the principles of the present invention.

As depicted in FIG. 7, a list of search results 700 relevant to a user search query is displayed on a results screen 710 on the single search client 550. The single search client 550 is able to request up to 10 (configurable) search results at a time. If more than 10 search results are available for a search query, an existing scroll model is used to display results on a single page.

When search is initiated via the search button 120, search query data is completely freeform and capable of prompting any type of search. Hence, a single search initiated by selection of the search button 120 provides no hint as to type of search (e.g. address search, POI search, etc.) to the single search server 500.

If a search query is sent to the single search server 500 when a data connection is unavailable, a conventional ‘data connection unavailable’ error is displayed on the single search client 550.

In another potential use case, a user begins typing characters into the single search box global 110 on one of a main application screen 100, an enter an address screen 300, or a find a place screen 400. Text input in the single search box global 110 prompts the single search client 550 to send a suggestion query to the single search server 500 for suggestion data. While a user is typing, the single search client 550 displays suggestions containing potential matches from client-side data and potential matches generated on the single search server 500, under the single search box global 110. A suggestion may represent one or more of the following items: a POI, a partial address, an airport, or a POI category.

Boosts are applied to certain suggestions depending upon what a user is searching for. For example, when a user begins typing characters into the single search box global 110 on the address screen 300, suggestions for address results are boosted (i.e. prioritized). Similarly, when a user begins typing characters into the single search box global 110 on the find a place screen 400, suggestions for POI results are boosted (i.e. prioritized).

FIG. 8 depicts exemplary display of suggestions on a single search client, in accordance with the principles of the present invention.

In particular, suggestions 800 are displayed on the single search client 550 as a search query 810 is input, character by character, in to the single search box global 110. As a user begins to enter text 810 in to the single search box global 110, search suggestions 800 begin to appear below the single search box global 110. For instance, single search client A 550a in FIG. 8 displays search suggestions, ‘Tan at the Islands’, ‘Tanner St Aliso Viejo, CA’, ‘Tango Tapas’, and ‘Café Tu Tu Tango’ 800a, in response to input text (i.e. text input in the single search box global 110), ‘tan’ 810a.

Single search client B 550b in FIG. 8, portrays exemplary display of search suggestions 800b with a keyboard 310. A keyboard 310 is displayed on the single search client 550b when focus is placed inside the single search box global 110. A suggestion list 800b is scrollable when more search suggestions are available than can be presented in the area above the keyboard 310. Initiation of scrolling serves to hide the keyboard 310, and the keyboard 310 is restored when a user places focus back inside the single search box global 110.

Single search client C 550c in FIG. 8 portrays exemplary display of search suggestions 800c without a keyboard 310.

In accordance with the principles of the present invention, the search servlet 510 returns suggested complete terms to the single search client 550 in response to a partial query term 810 typed in to the single search box global 110. Suggested complete terms are retrieved by the search servlet 510 and are relevant to a current location of a requesting client/user device. Up to 10 search suggestions are displayed on the single search client 550 at a time. Up to 5 suggestions are displayed on the map screen on the single search client 550 at a time.

If a data connection is unavailable when attempting to generate search suggestions, client-side suggestions are displayed on the single search client 550 and server-side suggestions are not. Client-side suggestions include suggestions for on-device data (i.e. favorites, contacts, and recent searches). More particularly, client-side suggestions include suggestions for matches found in a contact database on a client device, and matches found in recent searches and favorites items from the navigation application on the client device. A maximum of 2 client-side suggestions may be displayed on the single search client.

In another potential use case, no text is entered in to the single search box global 110 and a category (e.g. ‘Restaurants & Bars’, ‘Lodging’, ‘Shopping’, etc.) is selected from a category list 410 displayed on the find a place screen 400. In response to the category selection, the single search client 550 sends a proxpoi query 606 to the single search server 500. The proxpoi servlet 520 on the single search server 500 receives the proxpoi query 606 and returns search results (i.e. items stored under the selected category) for the selected category to the single search client 550, whereupon search results are subsequently displayed.

In another potential use case, some text is entered in to the single search box global 110 and a category is selected from a category list 410 displayed on the find a place screen 400. In response to the category selection, the single search client 550 sends a search query (comprising a reference to the selected category and text entered in to the single search box global 110) to the single search server 500. The search servlet 510 on the single search server 500 receives the search query, and returns matching search results from the selected category (e.g. ‘Restaurants & Bars’, ‘Lodging’, ‘Shopping’, etc.) to the single search client 550, whereupon results are subsequently displayed.

In another potential use case, a recent searches item is selected from a list of recent searches displayed under the single search box global 110. In accordance with the principles of the present invention, selection of a recent searches item prompts a detail screen containing data previously retrieved for that recent searches item to be displayed on the single search client 550.

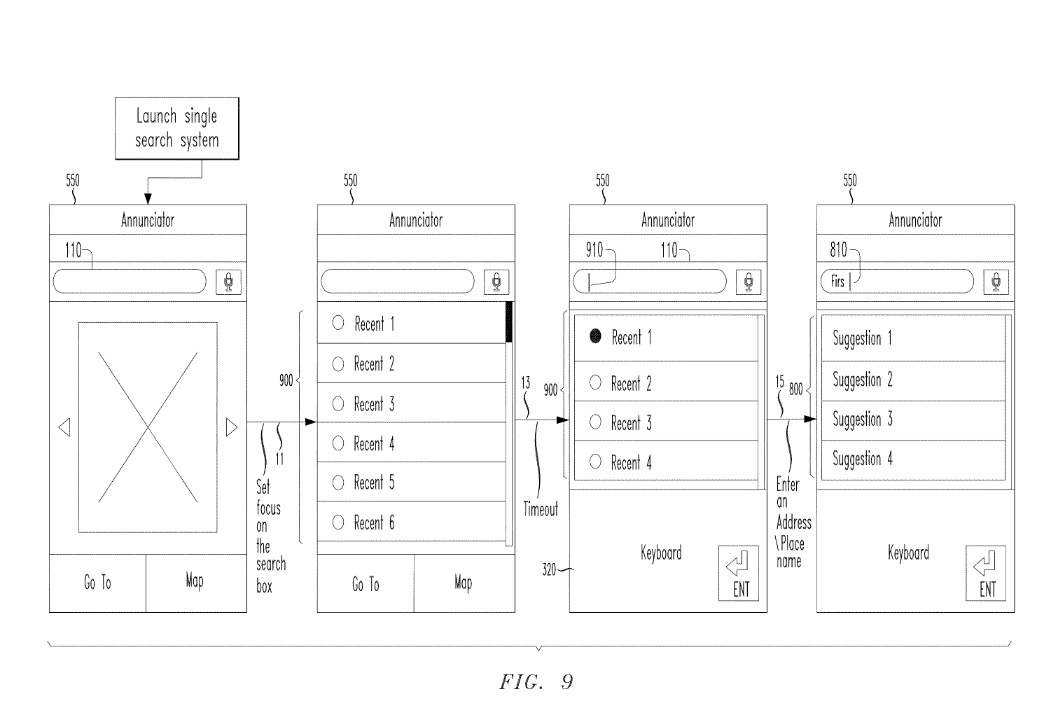

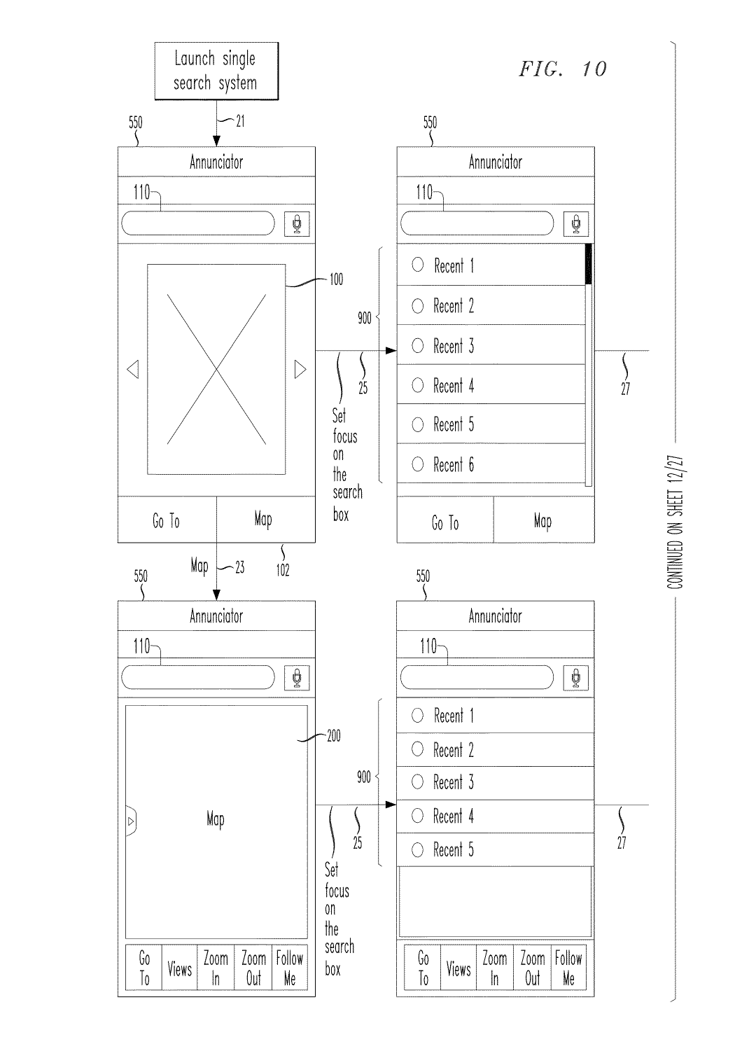

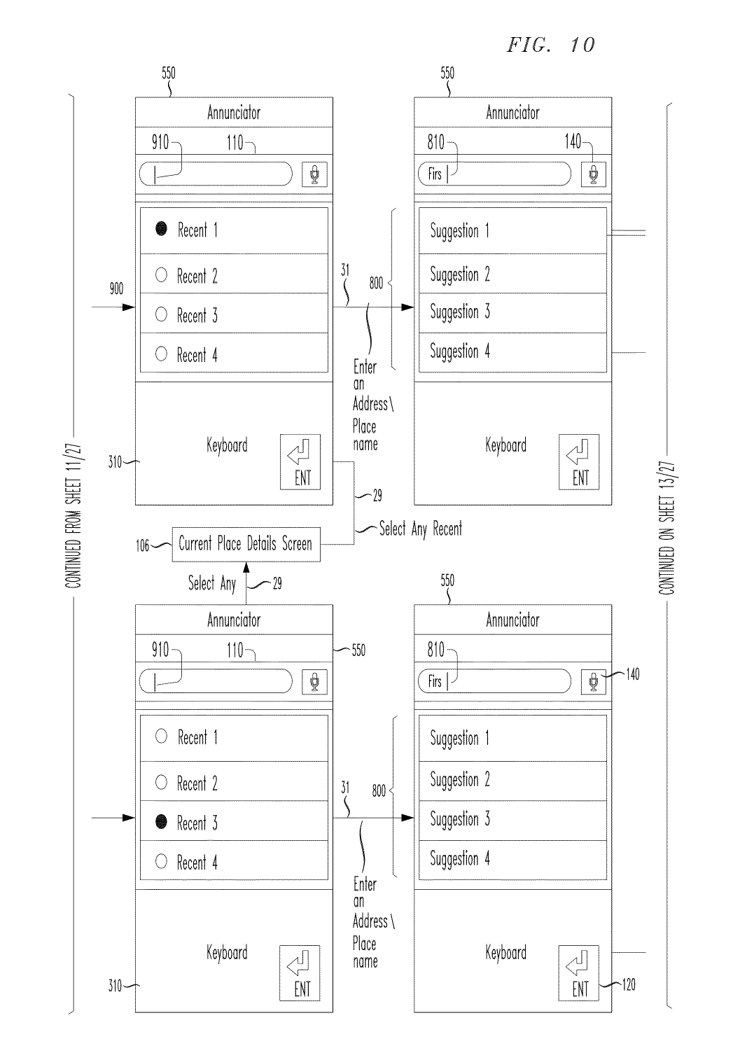

FIG. 9 portrays exemplary display of recent searches on a single search client, in accordance with the principles of the present invention.

In accordance with the principles of the present invention, a user's top 10 (configurable) recent searches 900 are displayed on the single search client 550 when focus is placed inside the single search box global 110 (step 11). Recent searches 900 are ordered chronologically, with a most recently used item positioned at the top of the list. As shown in step 15, when a user enters input text 810 in to the single search box global 110, the list of recent searches 900 is replaced with a list of search suggestions 800.

In another potential use case, a suggestion is selected from a list of suggestions 800 displayed under the single search box global 110. In accordance with the principles of the present invention, selection of a suggestion initiates a search for that suggestion item.

When search is initiated via selection of a suggestion item, the single search client 550 sends a search query (comprising a search-filter stored in that selected suggestion item) to the single search server 500 to request relevant data. The search servlet 510 on the single search server 500 receives the search query and returns data stored for the selected suggestion item to the single search client 550, whereupon data is displayed on a detail screen.

In yet another potential use case, a category is selected from a slide-out ‘map tray’ on the map screen 200 on the single search client 550. In response to the category selection, the single search client 550 sends a search query (comprising a reference to the selected category) to the single search server 500 to request relevant search results. The search servlet 510 on the single search server 500 receives the search query and returns relevant search results to the single search client 550, whereupon results are subsequently displayed.

In yet another potential use case, a single search is initiated via verbal instruction. In accordance with the principles of the present invention, the global single search system preferably uses native Google automatic speech recognition (ASR) on the Android platform to provide automatic speech recognition (ASR) functionality. A single search via verbal instruction is initiated via selection of the ASR button (i.e. the microphone button) 140 on the single search client 550. Recognized text from an automatic speech recognition (ASR) engine is input in to the single search box global 110 and sent to the search servlet 510 as a single search query. No search suggestions are provided for text that is input in to the single search box global 110 via automatic speech recognition (ASR), unless such text is edited in the single search box field 110 thereafter.

Single search via automatic speech recognition (ASR) is supported for any data corpus supported within the present invention. However, on-device data (i.e. favorites, contacts, and recent searches) is not searchable via automatic speech recognition (ASR). Search results are identical for identical search queries, irrespective of whether a search query is entered via text or voice.

The single search client 550 transmits a search query and receives a search response for any use case originating from the single search box global 110, any category-only search initiated via selection of a category from a category list 410, and any search initiated via selection of a suggestion item. In essence, the present invention is an intermediate step towards replacement of the existing proxpoi query 606.

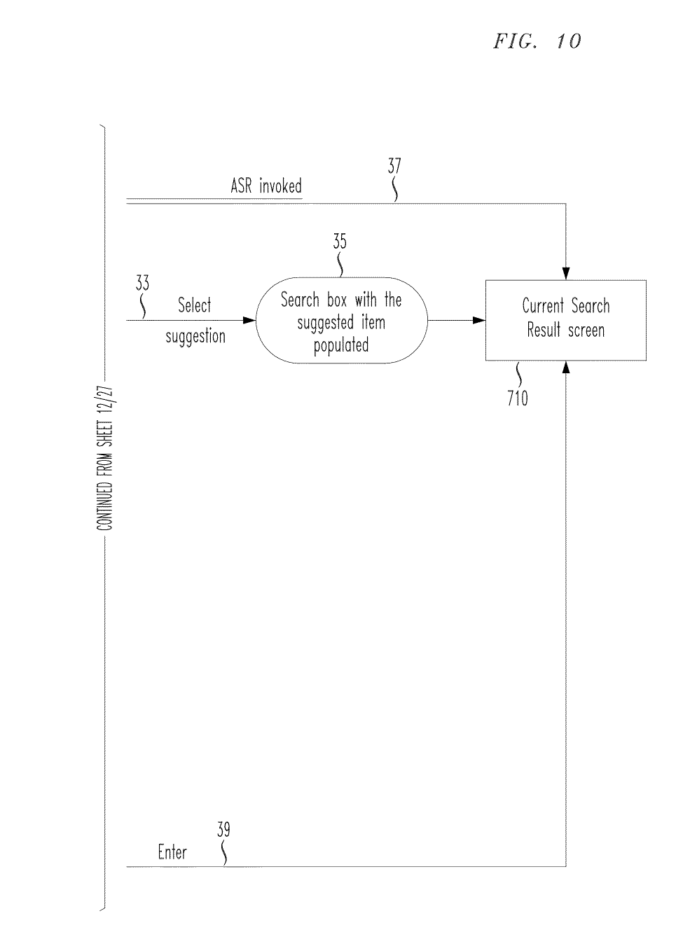

FIG. 10 depicts a user interface flow that demonstrates an exemplary single search behavior, in accordance with the principles of the present invention.

As depicted in step 21 of FIG. 10, a main application screen (in carousel view) 100 is displayed on the single search client 550 when the single search application is initially launched. As portrayed in step 23, a map screen 200 is displayed on the single search client 550 via selection of a ‘Map’ button 102 on the main application screen 100. Both the map screen 200 and the main application screen 100 on the single search client 550 contain a single search box global 110.

As portrayed in step 25 of FIG. 10, setting focus inside the single search box global 110 causes a list of recent searches (i.e. searches previously initiated on the single search client) 900 to be displayed under the single search box global 110.

As shown in step 29 of FIG. 10, selection of a recent searches item causes a detail screen 106 containing data for that selected item to be presented on the single search client 550.

Moreover, as shown in step 31, text input 810 in the single search box global 110, prompts a list of search suggestions 800 (generated for input text 810) to be displayed on the single search client 550, in lieu of recent searches 900. As depicted in step 33, selection of a suggestion item causes the selected suggestion to populate the single search box global 110 (step 35) and a single search for the selected suggestion to immediately ensue. Search results for a single search initiated on the suggestion item are displayed on a results screen 710 on the single search client 550.

As shown in step 37 of FIG. 10, selection of the automatic speech recognition (ASR) button 900 on the single search client 550, prompts the global single search system to retrieve a verbal search query and initiate a single search on that verbal search query. Search results for the verbal search query are displayed on a results screen 710 on the single search client 550.

As shown in step 39, selection of the search button 120 on the single search client 550 initiates a single search on a user search query input in the single search box global 110. Search results for the user search query are displayed on a results screen 710 on the single search client 550.

In accordance with the principles of the present invention, a proxpoi query 606 is used to carry out all use cases, except for cases that include searches initiated from the single search box global 110, category-only searches, and search suggestions. For instance, a proxpoi query 606 is used to carry out all carousal queries, and all explicit movie, event, gas price, and/or weather queries.

The servlet target for a proxpoi query 606 remains the same (the proxpoi servlet 520) for conventional clients 600. The servlet target for a single search query is the search servlet 510 for all clients (600 and 550).

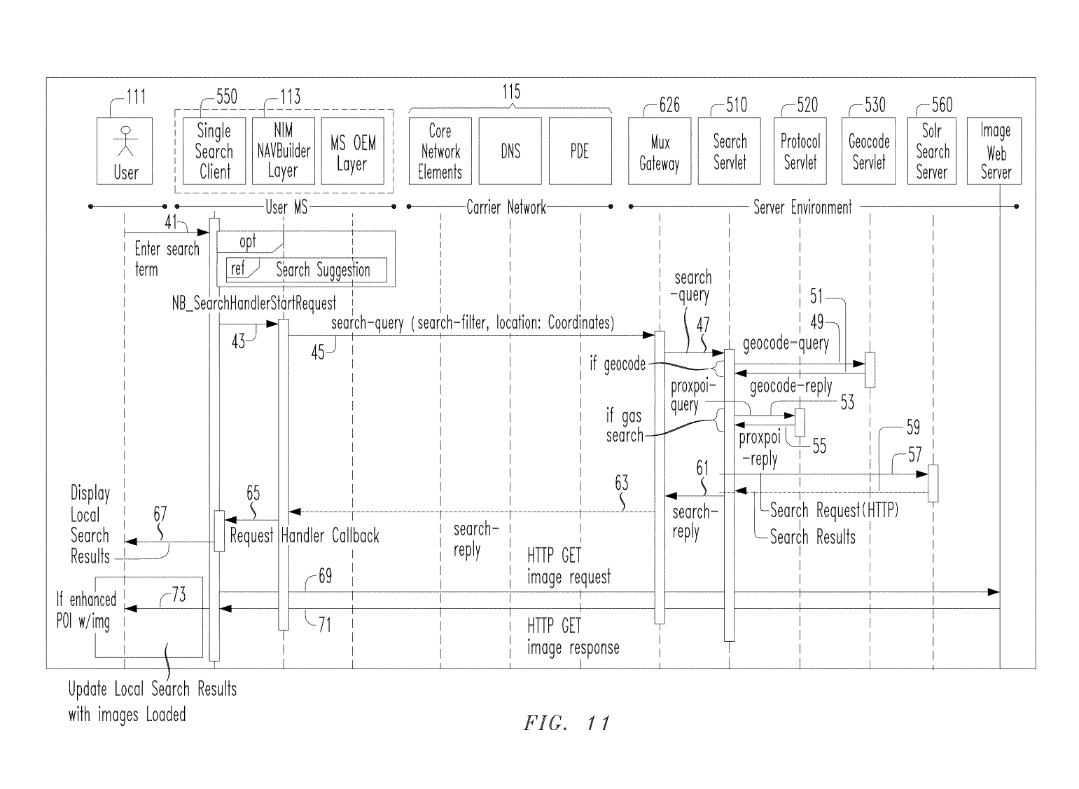

FIG. 11 shows an exemplary call flow demonstrating a search query and a search reply for a local search, in accordance with the principles of the present invention.

In particular, as depicted in step 41, a user 111 initiates a single search on the single search client 550 via a use case (e.g. via selection of the search button 120, via selection of a category, etc.) previously described herein. In response to the initiated single search, the single search client 550 initiates a search query by, e.g., sending an NB_SearchHandlerStartRequest to a NIM NAVBuilder Layer 113, as shown in step 43. Once the search query is initiated, a search query containing elements (e.g. an appropriate search-filter, location coordinates, etc.) relevant to the initiated single search is transmitted over the carrier network 115 to the single search server 500 (step 45). As depicted in step 47, a multiplexer 117 on the single search server 500 forwards the search query to the search servlet 510. If the search query is a conventional geocode query 602, then the search servlet 510 transmits an inter-servlet geocode query 604 to the geocode servlet 530 for appropriate geocode results, as shown in steps 49 and 51. Rather, if the search query is a conventional gas price query 606, the search servlet 510 transmits an inter-servlet proxpoi query 608 to the proxpoi servlet 520 for appropriate gas price results, as depicted in steps 53 and 55. Otherwise, the search servlet 510 sends an HTTP single search request to the Apache Solr™ search server 560 for relevant single search results (steps 57 and 59). As depicted in steps 61 and 63, a search response containing relevant search results is transmitted from the search servlet 510 back to the NIM NAVBuilder Layer 113. From the NIM NAVBuilder Layer 113, the search response is sent to the single search client 550 in a call back (e.g. a Request Handler Callback), as depicted in step 65.

If search results do not contain POIs enhanced with images, search results are displayed on the single search client 550, as shown in step 67.

Alternatively, if search results do contain POIs enhanced with images, the single search client 550 sends an HTTP GET image request to an image web server requesting images, as shown in step 69. In step 71, the image web server 560 returns an HTTP GET image response with image URLs to the single search client 550. Local search results are updated with loaded images and displayed on the single search client 550, as portrayed in step 67.

The global single search system maintains data sets for supporting single search, data sets for supporting single search on a global scale, and data sets for boosting relevance/display of search results. For instance, to support single search on a global scale, the global single search system supports and maintains data for multiple countries. The global single search system also maintains data sets to support multiple languages.

In accordance with the principles of the present invention, the global single search system supports a table of country names, a table of state/province names and a table of city names with exonym support, to enable search for country, city, and/or state/province names by exonym (i.e. names used by foreigners for a place, e.g., Florence for Firenze).

The global single search system additionally maintains a list of global landmarks and a list of category names with exonym and transliteration support (i.e. to transcribe —a word, etc., in one alphabet—into corresponding letters of another alphabet), e.g., Greek word [symbol] can be transliterated as “logos”. For example, the global single search system supports exonym, ‘Tour Eiffel’, for global landmark, ‘Eiffel Tower’. When performing a single search, the single search server 500 searches all available exonyms, regardless of setting and location.

The global single search system also provides exonym support for city names and popular POI category names (when provided by database providers), and transliteration support for POI names and addresses (when provided by database providers). For example, exonyms supported for city name, ‘Munich’, include ‘Munchen’ and ‘Minhen’. Moreover, an exemplary transliteration supported for POI name, ‘McDonald's’, includes ‘ [symbol] ’ (Russian). Transliteration support is provided in the language set on the single search client 550, regardless of a location of a requesting client/user device. For instance, if the language setting on the single search client 550 is set to English, and a requesting client/user device is located in Russia, then POI names appear on that single search client 550 in English.

The global single search system also maintains data sets for global and regional brands. A global brand is a brand with multiple locations in multiple countries. For example, Starbucks, Marriott Hotels, Costco, Carrefour, and McDonald's are all examples of global brands. A regional brand is a brand with multiple locations all concentrated within a limited geographic area. For example, In-N-Out Burger is a regional brand with multiple locations concentrated in the western states (mainly California). In accordance with the principles of the present invention, brands may be located in multiple countries but still not qualify as global brands. For instance, Norauto and MOS Burger are two regional brands (not global brands) with locations in multiple countries. Norauto (regional brand) is mainly concentrated in France, but also has locations in a few other European countries, plus Argentina. Similarly, MOS Burger (regional brand) is popular in Japan and also has locations in other Asian countries, plus Australia.

The global single search system uses data sets for global and regional brands to provide users with a faster and easier search experience. In particular, the global single search system returns search suggestions for global/regional brands to the single search client 550, following minimal data input in the single search box global 110. For example, when input text 810 ‘St’ or ‘Sta’ is input in the single search box global 110, the single search server 500 returns a search suggestion for global brand, ‘Starbucks’, to the single search client 550. If the search suggestion for global brand, ‘Starbucks’, is subsequently selected for search, the single search server 500 returns a list of nearby Starbucks locations to the single search client 550. Similarly, if input text 810 ‘No’ or ‘Nor’ is input in the single search box global 110, the single search server 500 returns a search suggestion for regional brand, ‘Norauto’, to the single search client 550. Then, if the search suggestion for regional brand, ‘Norauto’, is subsequently selected for search, the single search server 500 returns a list of nearby Norauto locations to the single search client 550.

In accordance with the principles of the present invention, the single search server 500 uses distance criteria to surface regional brands. Therefore, a search suggestion for ‘Norauto’ surfaces on a requesting client/user device located in France more quickly than a search suggestion for ‘Norauto’ surfaces on a requesting client/user device located in Scotland.

The global single search system also maintains a list of stadiums, fields, and arenas to aid global single search, as well as a list of alias names for stadiums, fields, and arenas supported within the present invention, since venues tend to change/gain sponsorship from time to time, and since stadiums are often searched by team name. For example, if the name of Dodger Stadium is changed to ‘Samsung Stadium’ because, e.g., Samsung leases the rights to the stadium name, then many users will likely still search for ‘Dodger Stadium’.

The global single search system additionally maintains a list of geographic borders (i.e. land boundaries between countries) for global single search. Each border maintained in the geographic borders data set contains an ease of crossing value, based on a particular direction of travel. An ease of crossing value awarded to a geographic border may be a number between 1 and 10, 10 representing a border that is easiest to cross. For example, an ease of crossing value for crossing from the United States to Mexico is 6, for crossing from Mexico to the United States is 3, for crossing from England to France is 8 (due to tunnel and side of road issues), for crossing from France to England is 8, for crossing from Germany to Belgium is 10, and for crossing from Belgium to Germany is 10.

To further aid single search, the global single search system maintains a list of common acronyms for each supported country. Exemplary acronyms include, ‘DMV’ for Department of Motor Vehicles (USA), ‘AAA’ for Automobile club (USA), ‘DF’ for Distrito Federal (Mexico) and ‘MOMA’ for Museum of Modern Art.

The global single search system uses the following data sets to rank order and/or boost relevant single search results: state capitals, province capitals, territory capitals, country capitals, cities with large populations, and popular/tourist cities.

A population cutoff for the cities with large populations data set may vary by state or country. Moreover, the popular/tourist cities data set includes well-known cities/tourist destinations that do not meet population criteria required for cities with large populations. For example, Big Sur, Calif. is a city stored in the popular/tourist cities data set. Big Sur, Calif. has a small population, but is a destination city for many tourists and therefore prioritized. State and/or country capitals are not stored in the data set for cities with large populations.

In accordance with the principles of the present invention, the global single search system uses data sets for relevance (i.e. state capitals, province capitals, territory capitals, country capitals, cities with large populations, and popular/tourist cities data sets) to rank relevant search results retrieved for a single search. The single search server 500 returns search results to the single search client 550 in order of decreasing relevance score (i.e. search results with high relevance scores are returned first).

Data sets for relevance enable the global single search system to return relevant search results to the single search client 550. For instance, the single search server 500 uses data sets for relevance to return relevant search results to the single search client 550 in response to a search query/input text containing a city name common to multiple cities. For example, based on data sets for relevance, the global single search system preferably returns search results for ‘Paris, France’ to the single search client 550 instead of search results for ‘Paris, Texas’, when search query, ‘Paris’, is entered in to the single search box global 110, regardless of whether a requesting client/user device is located closer to Paris, Tex. The exception to this rule is when a client/user device is located within a threshold distance (e.g. 25 miles) of a city with a matching city name, in which case search results for this matching city are returned first. For example, when search query, ‘Paris’ is entered in to the single search box global 110 on a client/user device located within a predetermined threshold distance (e.g. 25 miles) of Paris, Tex., then search results for Paris, Tex. are returned to the single search client 550 first. A threshold distance is determined for a city based on city rank. For instance, a threshold distance for a small city, such as Paris, Tex., may be as small as 25 miles, whereas a threshold distance for a mid-size city, such as London, Ontario, may be up to 100 miles.

The global single search system also uses data sets for relevance to order POI matches and city name matches, when both are relevant to a user search query. For example, ‘Fairmont’ is both the name of a city and a hotel chain. If search query, ‘Fairmont’, is entered in to the single search box global 110 on a client/user device located in Los Angeles, then the global single search system uses data sets for relevance to determine that a user is likely searching for Fairmont Hotels and not Fairmont, Minn.

In accordance with the principles of the present invention, the global single search system considers the following data corpuses for purposes of single search: points of interest (POI) (including global landmarks), POI categories, addresses (street names, cities, states, provinces, countries, zip codes), gas stations, favorites, contacts, recent searches, airports, movies, and events.

The airports data corpus supported herein differentiates commercial airports from non-commercial airports so that airports may be filtered as needed. Moreover, the POI categories data corpus supports each language supported within the present invention. POI category names are presented on the single search client 550 in the language the single search client 550 is set to. For example, if the language setting on the single search client 550 is set to Spanish, then only Spanish category names are searched and displayed on the single search client 550.

A user may enter a search query in to the single search box global 110 to convey a search intent that spans one or more data corpuses listed above. In accordance with the principles of the present invention, meta-data concerning a nature of a search is not provided to the single search server 500, thus the search servlet 510 must search against all available data corpuses to find relevant search results.

The following source parts of each of the data corpuses listed above are considered for purposes of single search: name, category (for points of interest); street number, street address, city, state/province, country, zip (for addresses); gas station name (for gas stations); favorite name, street number, street address, city, state, country, zip (for favorites); contact name, street number, street address, city, state, country, zip of ALL (home, work etc.) contact addresses (for contacts); recent searches (for recent searches); airport name, airport code, airport city (for airports); movie name, genre (for movies); and event name, event type (for events). Admin hierarchy for address parts is defined on a country by country basis and may contain up to 9 levels.

To determine suggestion candidates, input text 810 (i.e. text input in the single search box global 110) is compared to every word of every data source part. If input text 810 matches the start of any word of any available data source item, then that data source item is considered a match and displayed on the single search client 550 as a suggestion ordered by distance to the search center. Suggestion candidates are continuously determined and refined as additional characters are entered in to the single search box global 110. Stop words are not considered for purposes of determining a suggestion candidate. For instance, ‘Chilis Bar and Grill’ is not a suggested item in response to input text 810, ‘an’.

In accordance with the principles of the present invention, specific matching criteria used to search for search suggestions is based on a number of characters entered in to the single search box global 110. In particular, as the number of characters entered in to the single search box global 110 increases, more data sets are added to a search. For example, when only one character is entered in to the single search box global 110, the search string is matched against major cities (i.e. states, provinces, territories, country capitals, cities with large populations, and popular cities/tourist destinations) and international brands. When a second character is entered in to the single search box global 110, the search string is matched against major cities (i.e. states, provinces, territories, country capitals, cities with large populations, and popular cities/tourist destinations), international brands, and landmarks. When three characters are entered into the single search box global 110, the search string is matched against major cities, international brands, landmarks, countries, and POIs; and when four characters are entered in to the single search box global 110, the search string is matched against major cities, international brands, landmarks, countries, POIs, and addresses.

In one embodiment, the global single search system limits a search for POI suggestions based on a first 3 or 4 characters entered in to the single search box global 110 to POI items that are most commonly searched (e.g. restaurants and retail businesses). In this embodiment, POI items that are not as popular (e.g. accountants and attorneys) are not searched until a later character (e.g., at least a 5^{th} character) is entered in to the single search box global 110.

The global single search system also implements stringent matching on client data. Rules for matching against data stored on the single search client 550 are updated to reduce instances where only part of an entry matches what is stored on the single search client 550. In particular, search is repeated upon each character entry to ensure that accurate suggestions are returned to the single search client 550. For example, when a user searching for ‘Marriott’, types input text, ‘Marr’, in to the single search box global 110, search suggestions such as, ‘Mary Perkins’ and ‘Marty Maki’ (i.e. contacts suggestions), are no longer considered matches following input of the second I, and are therefore no longer returned to the single search client 550.

The single search server 500 returns matching suggestion candidates to the single search client 550 in response to input text entered in to the single search box global 110.

For instance, when input text 810 maps directly to a POI category name (or a predefined category alias), the single search server 500 returns a single category suggestion to the single search client 550, followed by suggestions based on the original search query.

For example, when input text 810 ‘food’ is entered in the single search box global 110, the single search server 500 detects that ‘food’ is an alias for POI category, ‘Restaurants and Bars’. Hence, the single search server 500 returns a suggestion for POI category, ‘Restaurants and Bars’, to the single search client 550, and additionally searches for other suggestions matching search term, ‘food’. In this case, the category suggestion is the first result returned to the single search client 550, whereas additional suggestions are returned in order of total relevance. The global single search system maintains a POI category list for all supported languages.

In accordance with the principles of the present invention, when input text 810 maps directly to a city name that is common to multiple cities (e.g. ‘Springfield’), the single search server 500 first returns a suggestion for a major city (i.e. a state, province, territory, country capital, city with a large population, or popular/tourist city), followed by a suggestion for a city nearest a center point of search (provided the nearest city is not the same as the first city suggestion returned), followed by matching POI and/or address suggestions. For example, when input text 810, ‘Springfield’, is entered in to the single search box global 110 on a client/user device located in Florida, the single search server 500 preferably returns search suggestion, ‘Springfield, MO’, to the single search client 550, followed by search suggestion, ‘Springfield, FL’, unless the client/user device is located within a threshold distance (e.g. 25 miles) of Springfield, Fla., in which case search results for Springfield, Fla. are returned first.

When a POI name is input in to the single search box global 110, along with a city name that is common to multiple cities, the single search server 500 returns city suggestions to the single search client 550 in the following order: exact city matches located within 100 miles of a requesting client/user device, exact city matches from relevance data sets, close city matches located within 100 miles of a requesting client/user device, and exact city matches located beyond 100 miles of a requesting client/user device (provided exact city matches beyond 100 miles of a requesting client/user device are not the same as exact city matches from relevance data sets). For example, when input text 810, ‘Starbucks Springfield’, is entered in to the single search box global 110 on a client/user device located in Atlanta, Ga., the single search server 550 preferably returns the following search suggestions to the single search client 550 in the following order: ‘Starbucks near Springfield, Virginia’ and ‘Starbucks near Springfield, Missouri’.

When input text 810 maps directly to a city, state, province, or country name, and additionally maps directly to a POI name or a partial POI name, then suggestions are presented on the single search client 550 in the following order: city/state/province/country name matches, followed by POI name matches (exact or partial) sorted by distance. For example, if input text 810, ‘Bangkok’, is typed in to the single search box global 110, the following suggestions are preferably displayed on the single search client 550 (in the following order): ‘Bangkok, Thailand’, ‘Bangkok (Restaurant)’, and ‘Bangkok Thai Cuisine (Restaurant)’. Moreover, if input text 810, ‘Texas’, is typed in to the single search box global 110, the following suggestions are preferably displayed on the single search client 550 (in the following order): ‘Texas (State)’, ‘Texas (Restaurant)’, and ‘Texas Roadhouse (Restaurant)’. Similarly, if input text 810, ‘Brazil’, is typed in to the single search box global 110, the following suggestions are preferably displayed on the single search client 550 (in the following order): ‘Brazil (Country)’, ‘Brazil (Restaurant)’, and ‘Texas de Brazil (Restaurant)’.

In some cases, input text 810 may contain a state or city location reference and a search term that maps directly to both a POI name and a POI category name. For example, input text 810, ‘Texas Barbecue’, and input text 810, ‘Chicago Pizza’, are both examples of input text 810 with a location reference and a search term that could pass as a POI name or a POI category name. To address such cases, the global single search system employs a combination of matching and distance criteria to determine suggestion candidates. For example, when input text 810, ‘Chicago Pizza’, is typed in to the single search box global 110, search suggestion, ‘Pizza near Chicago, Illinois’, (a category suggestion) is preferably displayed on the single search client 550, followed by a list of matching POI suggestions (in order of increasing distance from a requesting client/user device).

Moreover, if search query, ‘Chicago Pizza’, is entered in to the single search box global 110, the single search server 500 may return search results with data that neither corresponds to a POI name nor a POI category name. For instance, the single search server 500 may return a search result for ‘Chicago Pizza’, that contains data for a specialty on a restaurant menu.

The global single search system implements a new location reference extraction method for identifying location references in input text 810. In accordance with the principles of the present invention, the location reference extraction method supports multiple countries and multiple languages.

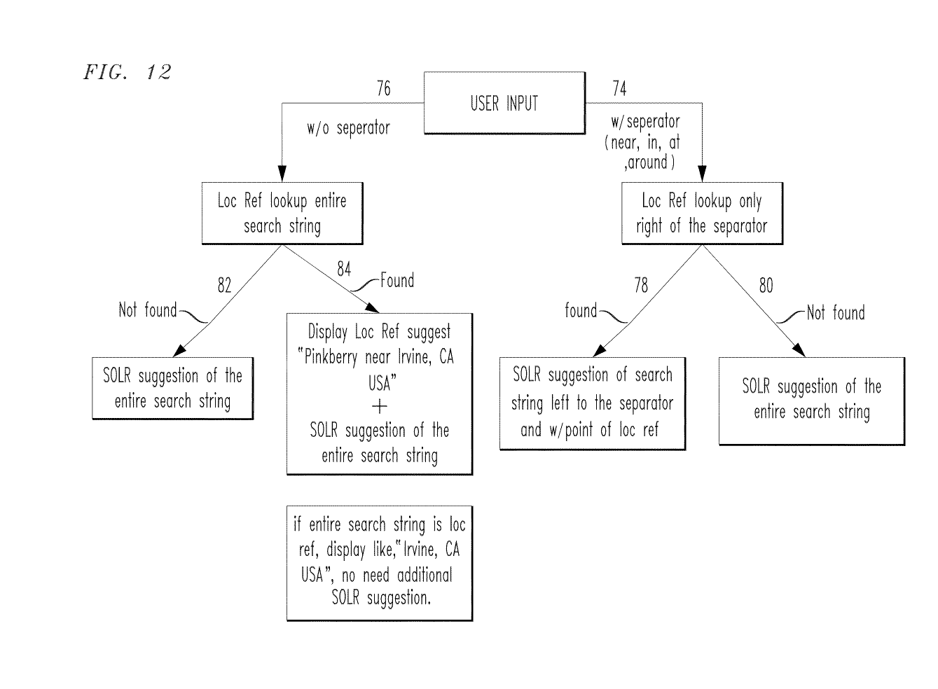

FIG. 12 depicts an exemplary flow diagram for identifying location references in input text, in accordance with the principles of the present invention.

As depicted in FIG. 12, the single search server 500 first searches input text (i.e. text input in to the single search box global 110) 810 for a separator word (e.g. ‘in’, ‘near’, ‘at’, and ‘around’). As shown in step 74 of FIG. 12, if the single search server 500 identifies a separator word in input text 810, then the single search server 500 performs a location reference lookup on the input text 810 to the right of the separator word.

To perform a location reference lookup, the single search server 500 first searches input text 810 for a possible zip token. In accordance with the principles of the present invention, a zip token cannot be the first token in input text 810 unless that zip token is the only token in input text 810.

Following zip search, the single search server 500 sends a query to the SOLR server 560 to initiate search for location matches based on input text 810.

During a location reference lookup, the single search server 500 initiates the following variables: g_city, g_city_saved, g_state, and g_zip. Variable g_city_saved is reserved for a first city found.

For each suggestion result, if doc_type=city, and an exact match (not a partial match) for that city is identified in input text 810, then that suggestion result is saved in variable, g_city. The global single search system additionally saves the city position in input text 810 and the city token position in input text 810 for that city match. For example, if a city token begins at a 4^{th} token in input text 810, then that city token has a city token position value of 3.

If more than one city result is an exact match for a search term in input text 810, then the single search server 500 stores the rightmost city match to variable, g_city. For example, the single search server 500 differentiates between city matches, ‘San Francisco’ and ‘Francisco’ to determine a most relevant city match. The single search server 500 then implements the same tasks performed for doc_type=city, for doc_type=state and doc_type=zip.

When search for city, state, and zip tokens in input text 810 is complete, the single search server 500 saves the leftmost city token identified in input text 810 to variable, g_city_saved.

If, after checking all SOLR results, it is known that tokens in input text 810 to the right of variable, g_city, are not state, country, or zip tokens, then either g_city_saved is identified as a location reference in input text 810, or no location reference is identified in input text 810.

Moreover, if variable, g_city_saved, does not correspond to the first token in the input text 810, then the single search server 500 must assure that all tokens to the left of g_city_saved are location references, e.g., state, zip, etc. If all tokens to the left of g_city_saved are not identified as location references, then no city location reference is identified for that input text 810.

The global single search system supports location references positioned in the front or the back of a search term, but not in the middle of a search term.

If the single search server 500 identifies a location reference in input text 810, then the single search server 500 validates variables: g_city, g_state, and g_zip, and assigns output priority in the following order: zip, city, state.

As depicted in step 78, if a location reference is identified in input text 810 to the right of the separator word, then the single search server 500 sends a suggestion query to the SOLR server 560 for search suggestions based on input text 810 to the left of the separator word. The suggestion query sent by the single search server 500 centers search on the identified location reference.

As shown in step 80, if a location reference is not found in input text 810 to the right of the separator word, then the single search server 500 sends a suggestion query to the SOLR server 560 requesting suggestions based on the entire input text 810.

In step 76 of FIG. 12, if the single search server 500 does not find a separator word in input text 810, then the single search server 500 performs a location reference lookup on the entire input text 810. Location reference lookup is performed on the entire input text 810 in the same manner that location reference lookup is performed on input text 810 to the right of the separator word (as previously described in step 74). In step 82, if no location references are identified in input text 810, then the single search server 500 sends a suggestion query to the SOLR server 560 for suggestions based on the entire input text 810.

Alternatively, if the single search server does detect at least one location reference in input text 810 (step 84), then the single search server 500 returns a suggestion for the identified location reference (e.g. ‘irvine, CA, USA’) to the single search client 550, and additionally sends a suggestion query to the SOLR server 560 for suggestions based on the entire input text 810 (as long as input text 810 contains more than just a location reference). If input text 810 contains a location reference only, then the single search server 500 returns only a suggestion for that location reference to the single search client 550.

The following search terms depict exemplary input text 810 supported by the global single search system: ‘New York pizza’, ‘China Garden Irvine’, ‘English Tea Time’, ‘three stars Saw & Tool’, ‘Lane Motor Museum’, ‘George Washington Bridge’, ‘The Arena at Gwinnett Center’, ‘Pinkberry near Irvine’ and ‘Oriole Park at Camden Yards’.

In accordance with the principles of the present invention, when input text 810 does not include a location reference, a suggestion list preferably indicates brands and/or categories located ‘nearby’ a requesting client/user device. For example, if input text 810, ‘Burger King’, is typed in to the single search box global 110, or if search term, ‘Burger King’, is displayed at some point during data entry, then a suggestion for a nearby Burger King is displayed on the single search client 550 as follows: ‘Burger King nearby’. A ‘nearby’ indication is presented in search suggestions only (not in search results).

The global single search system also uses a ‘near’ indication when displaying certain search suggestions for branded POIs or POI categories. In particular, when input text 810 includes a major brand or POI category name and a city name location reference, the single search server 500 preferably returns a suggestion for that major brand or POI category name, with an indication that that major brand/POI category name is ‘near’ the city name indicated in the input text 810. For example, when input text 810, ‘Burger King Anaheim’, is entered in to the single search box global 110, the single search server 500 preferably returns search suggestion, ‘Burger King near Anaheim, CA’, to the single search client 550. Similarly, when input text 810, ‘Car Rental Anaheim’, is entered in to the single search box global 110, the single search server 500 preferably returns search suggestion, ‘Car Rental near Anaheim, CA’, to the single search client 550.

In accordance with the principles of the present invention, the global single search system links global and regional brands to parent categories, and surfaces parent categories in search suggestions when input text contains a POI subcategory or a branded POI that is not located nearby. For example, a user may relocate from the United States to Italy. While in Italy, that user may type input text 810, ‘Home Depot’, in to the single search box global 110. There are no Home Depots located in Italy. Therefore, the single search server 500 preferably returns a suggestion for Home Depot's parent category, ‘Home Repair’, to the single search client 550. In another example, input text 810, ‘Starbucks’, is typed in to the single search box global 110 on a client/user device located 100 miles away from the nearest Starbucks location. In this case, parent category, ‘Coffee Shop’, is preferably surfaced in a suggestion list 800 displayed on the single search client 550, as it is likely that a user is searching for coffee.

When multiple search suggestions are relevant to a city search, priority is given to the following suggestion types in the following order: suggestions for popular/major cities (e.g. Paris, France), suggestions for closest cities (e.g. Paris, Tex., USA), ‘<Search Term> near me’ suggestions (e.g. Paris near me), category suggestions (if relevant), and suggestions for matching street names and POI names. Popular/major city suggestions and closest city suggestions are limited to 2 suggestion positions, total. Only cities in a current region or a popular/major city are considered for determining suggestion candidates. Also, when determining suggestion candidates, popular/major city matches take priority over state/province matches and country matches. Suggestions include distance attributes when a request for distance attributes is made on the single search client 550.

In determining POI, address, or airport suggestion candidates, a limited search boundary is not enforced.

In accordance with the principles of the present invention, different types of suggestions contain different item attributes. For instance, a suggestion for a POI item contains a POI name and an address. For example, ‘Chillis Bar and Grill, 26632 Aliso Creek Rd, Aliso Viejo, CA’ is a valid POI suggestion in response to input text 810, ‘chi’.

A suggestion for a POI category contains a POI category name. For example, “Chinese Restaurants' is a valid POI category suggestion in response to input text 810, ‘chi’.

A suggestion for a street name contains a street name, city, and state. For example, ‘Chabot Road, Laguna Niguel, CA’ is a valid street name suggestion in response to input text 810, ‘chab’.

A suggestion for a city name contains a city and state. For example, ‘Chicago, IL’ is a valid city name suggestion in response to input text 810, ‘ch’.

A suggestion for a state name contains a state. For example, ‘North Carolina’ is a valid state name suggestion in response to input text 810, ‘ca’.

A suggestion for a country name contains a country. For example, ‘Argentina’ is a valid country name suggestion in response to input text 810, ‘arg’.

A suggestion for a zip code contains a city, state, and zip code. For example, ‘Boston, CA, 02115’ is a valid zip code suggestion in response to input text 810, ‘02115’.

A suggestion for a contact name contains a contact name and address. For example, ‘Charles De Gaulle, 100 Pennsylvania Ave, Washington, D.C.’ is a valid contact name suggestion in response to input text 810, ‘cha’.

A suggestion for a favorite name contains a favorite name and address. For example, ‘Hard Rock Café, Las Vegas, CA’ is a valid favorite name suggestion in response to input text 810, ‘caf’.

A suggestion for an airport contains an airport name, city, and state. For example, ‘Boston Logan International Airport, Boston, MA’ is a valid airport suggestion in response to input text 810, ‘log’.

Suggestion candidates that are geographically closer to a requesting client/user device are considered more relevant than suggestion candidates that are further away. The present invention uses a fast but approximate distance calculation to compute geographic proximity (as opposed to a more precise but slower method).

In accordance with the principles of the present invention, suggestions are grouped into two buckets, one bucket comprising server-generated items and the other bucket comprising client-generated items. Up to ten relevant suggestions may be presented on the single search client 550 at a time. Of those ten relevant suggestions, two suggestions are reserved for client-generated suggestions (when client-generated suggestions are available) and 8 suggestions are reserved for server-generated suggestions. However, if fewer than eight server-generated suggestions are available, and more than two client-generated suggestions are available, then unfilled server slots are used for client-generated suggestions. The single search client 550 is engineered so that it may easily be switched to display client-generated suggestions first and server-generated suggestions second, if later deemed necessary.

Server-generated suggestions are ordered by relevance, with a most relevant item (usually the item that is geographically closest to the requesting client/user device or a center of search) positioned at the top of the list. Relevance ordering applies to search results, as well. For instance, when a user selects the search button, search results are presented on the single search client 550 in order of relevance. Client-generated suggestions are ordered alphabetically.

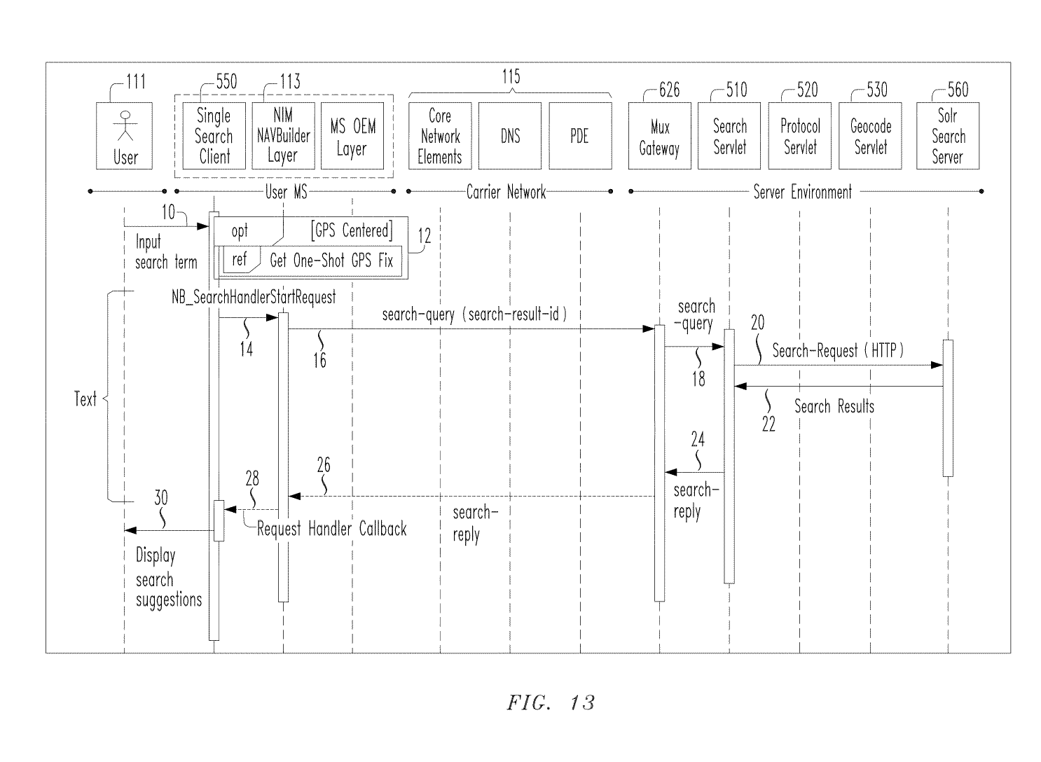

FIG. 13 depicts an exemplary call flow demonstrating a search query and a search reply for suggestions, in accordance with the principles of the present invention.

In particular, as depicted in step 10 of FIG. 13, text is input in to the single search box global 110 on the single search client 550. Once focus is placed inside the single search box global 110, a coarse location fix is retrieved for a requesting client/user device (step 12). If a last known fine fix for the requesting client/user device is less than 2 minutes old, then that last know fine fix is used to generate suggestions/search results. Otherwise, the coarse location fix is used. For iOS, course fix with a 10000 m accuracy filter is preferably used.

As depicted in step 14, the single search client 550 initiates a search handler in response to input text 810, by, e.g., sending an NB_SearchHandlerStartRequest to a NIM NAVBuilder Layer 113. Once the search handler is initiated, a search query for suggestions (i.e. a search query with a ‘suggest’ search-filter and current location coordinates) is transmitted over the carrier network 115 to the single search server 500, as shown in step 16. As depicted in step 18, a multiplexer 117 on the single search server 500 forwards the search query to the search servlet 510. The search servlet 510 receives the search query (i.e. suggest query) and sends an HTTP single search request to the Apache Solr™ search server 560 for relevant suggestion results, as shown in steps 20 and 22. In steps 24 and 26, a search response containing relevant suggestion results is transmitted from the search servlet 510 back to the NIM NAVBuilder Layer 113. From the NIM NAVBuilder Layer 113, the search response is sent to the single search client 550 in a callback (e.g. a Request Handler Callback) and suggestions are subsequently displayed thereon (steps 28 and 30).

Each character entered in to the single search box global 110 invokes the call flow depicted in FIG. 13. Suggestions returned to the single search client 550 may be of any searchable data type stored in the global single search system.

If suggestion generation is expected to take more than 1 second to complete, a spinning activity indicator is displayed inside the single search box global 110. This spinning activity indicator is stopped when search results are found, or when an error is returned from the single search server 500. User input is not blocked by suggestion generation.

A long press on a search suggestion is used as a mechanism to edit that selected suggestion. When a long press is implemented on a search suggestion, a suggestion string stored in that selected suggestion populates the single search box global 110. The suggestion string in the single search box global 110 may then be edited and the search button 120 (e.g. magnifying glass button, ‘enter’ key, etc.) may be manually selected to initiate a search.

A tap on a search suggestion (as opposed to a long press) automatically initiates a search on that suggestion item.

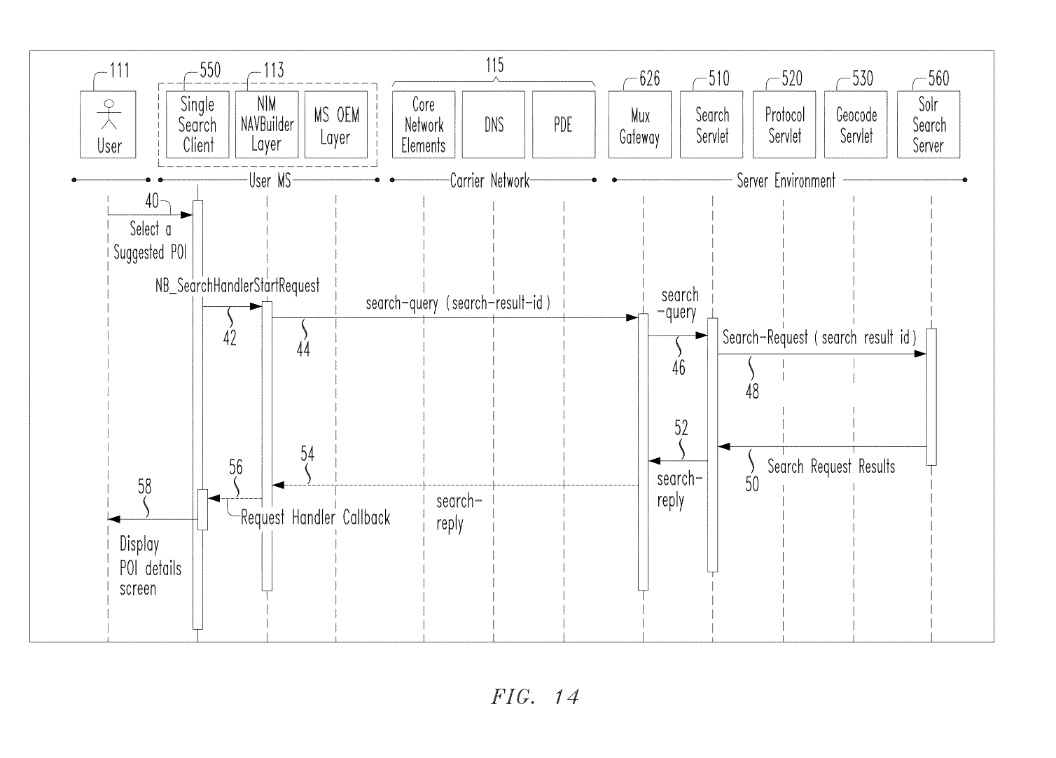

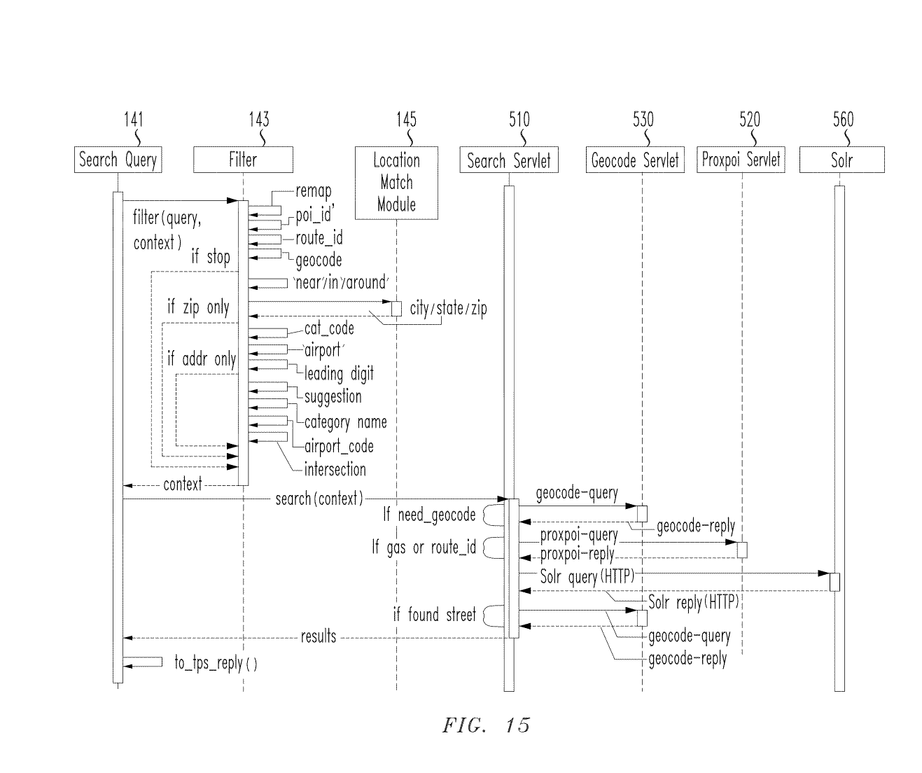

FIG. 14 portrays an exemplary call flow demonstrating a search query and a search reply for a selected POI suggestion, in accordance with the principles of the present invention.

As depicted in step 40 of FIG. 14, a user selects a POI suggestion displayed under the single search box global 110 on the single search client 550. In response to the suggestion selection, the single search client 550 initiates a search handler by, e.g., sending an NB_SearchHandlerStartRequest to a NIM NAVBuilder Layer 113, as shown in step 42. Once the search handler is initiated, a search query, containing a search-result-id retrieved from the suggestion item, is transmitted over the carrier network 115 to the single search server 500, as depicted in step 44. In step 46, a multiplexer 117 on the single search server 500 forwards the search query to the search servlet 510. As depicted in steps 48 and 50, the search servlet 510 receives the search query and sends a search request (containing a search-result-id retrieved from the suggestion item) to the Apache Solr™ search server 560 for relevant search results. A search response containing relevant search results is then transmitted from the search servlet 510 back to the NIM NAVBuilder Layer 113, as shown in steps 52 and 54. From the NIM NAVBuilder Layer 113, the search response is sent to the single search client 550 in a callback (e.g. a Request Handler Callback) (step 56) and a POI detail screen containing data for the selected POI item is subsequently displayed thereon (step 58).

If upon selection of a suggestion item, it is known that the suggestion item will yield exactly one search result upon search, then a results set is bypassed on the single search client 550 and an item detail screen for the selected suggestion is displayed instead. For example, upon selecting a suggested contact, a contact detail screen for that selected contact is presented on the single search client 550. Moreover, upon selecting a suggested POI item (a suggested POI item that includes a POI address), a POI detail screen for that selected POI is presented on the single search client 550. Further, upon selecting a suggested address, an address detail screen for that selected address is presented on the single search client 550.

If a user does not select an item from a list of suggestion items or if search suggestions are unavailable to a user, then tapping on the search button 120 (i.e. an ‘enter’ key) initiates search.

Being that a single search box global 110 is able to support a variety of input styles, it is often difficult to know for certain what type of search results a user is intending to acquire. The manner in which a search query is handled depends greatly upon whether that search query is intended for an address search or for a POI search. In accordance with the principles of the present invention, the single search client 550 passes a search query through a context filtering sequence to decipher user intent.

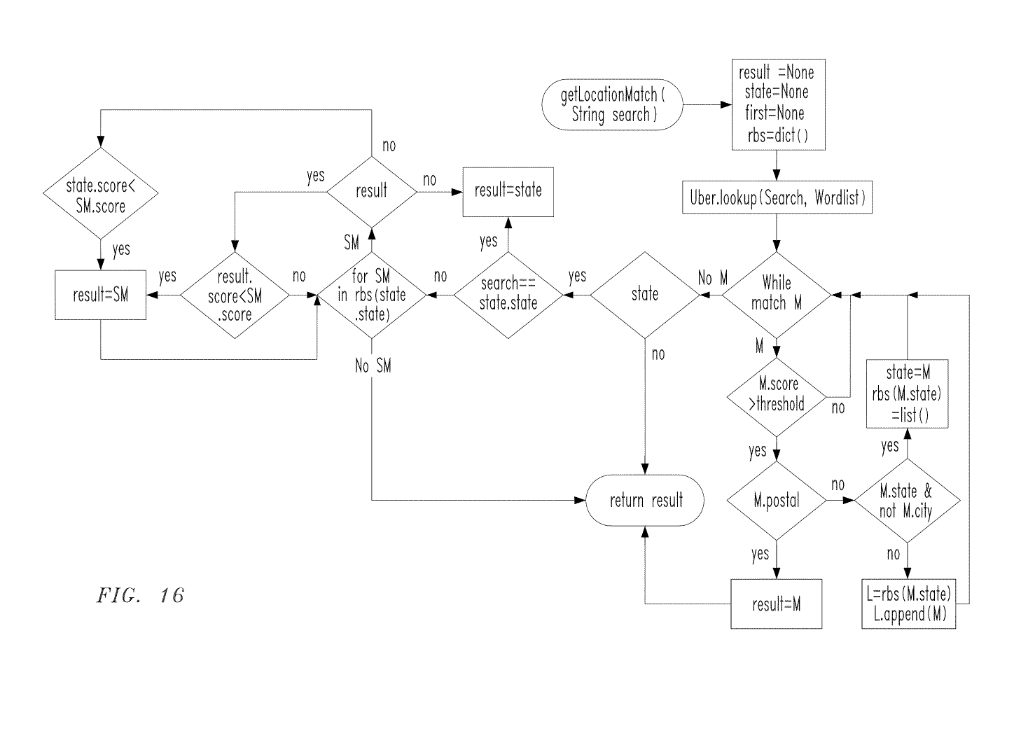

FIG. 15 depicts an exemplary context filtering sequence, in accordance with the principles of the present invention.

As depicted in FIG. 15, each search query 141 entered in the single search box global 110 is converted from TPS protocol elements/attributes to a searchQuery object, and then passed into a contextFilter 143 for processing.

In accordance with the principles of the present invention, the global single search system applies several assumptions when performing address-specific filtering. In particular, when filtering a search query for address data, the present invention assumes that a term beginning with a digit is likely a street number (i.e. matching result items containing a street number are awarded a higher relevance score). Terms ‘in’, ‘near’, and ‘around’ accompanied by pre- and post-terms within a search query, indicate that some portion of an address may follow. Also, the term ‘in’ in a search query for address data likely represents a state abbreviation or an address separator. In accordance with the principles of the present invention, a query term that matches a city name that is common to multiple cities is not considered a location reference when no additional location references are embedded in that search query.

When a potential city name is the only piece of data entered in the single search box global 110, the single search server 500 treats that city name as a POI query. For example, ‘Washington’ is a potential city name. However, ‘Washington’ is also a potential state name and a common surname. Therefore, the term, ‘Washington’, alone, is too ambiguous to use as a location reference. When both city name and state name (or state abbreviation) make up a complete search term, a geocoded city center for that city and state (e.g. Aliso Viejo, Calif.) is returned by the single search server 500.

When a street name is input in to the single search box global 110 without a street number, the single search server 500 does not return an address range in reply. Instead, the single search server 500 returns a street name, a city, a state, and a center-point of the combined street segments. For example, search query, ‘timbo street Irvine, ca’, corresponds to several stored data entries, e.g., [1-4] Timbo Street, Irvine, Calif.; [5-7] Timbo Street, Irvine, Calif.; [8-9] Timbo Street, Irvine, Calif.; etc. Each relevant data entry represents a different part of a street and contains a different start and end point (based on number ranges). A valid suggestion for search query, ‘timbo street Irvine, ca’, is ‘Timbo St. Irvine CA’, in accordance with the principles of the present invention.

Moreover, the global single search system drops alpha characters that are embedded in a street number in a search query, unless a map database contains information necessary to validate alpha characters. For example, if search query, ‘6A Liberty Aliso Viejo, CA’, is entered in to the single search box global 110, search (via geocode) returns address ‘6 Liberty Aliso Viejo, CA’.

When filtering a search query for city, state/province, and postal code, a city, state, zip (CSZ) lookup module is used.

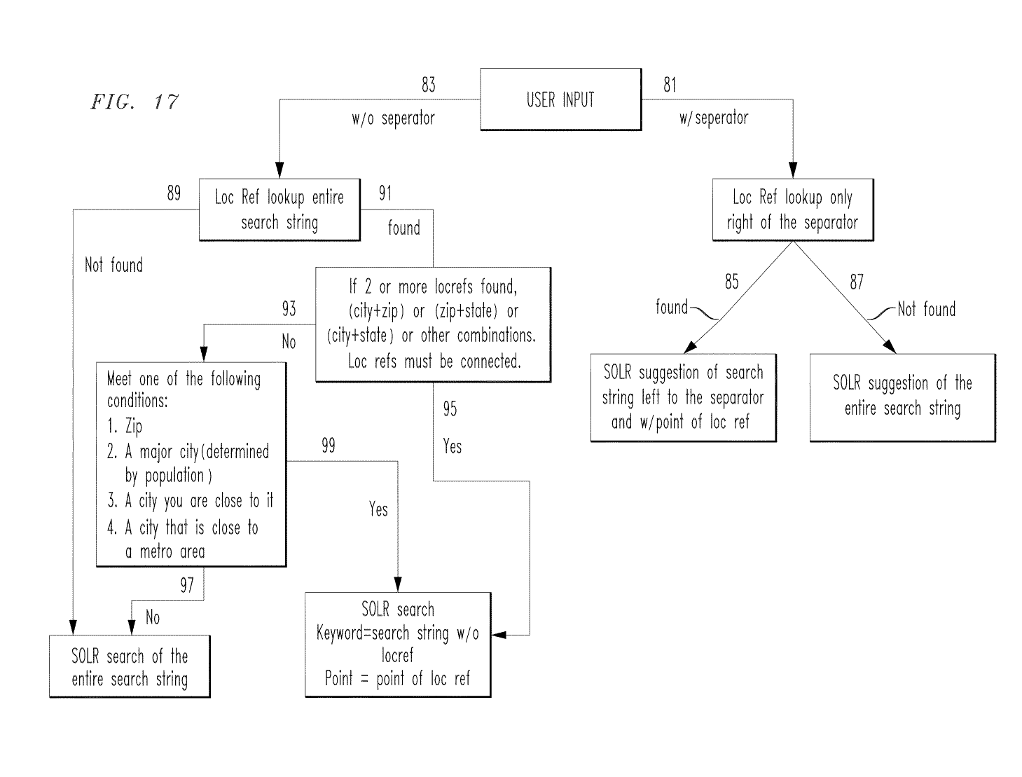

FIG. 16 depicts an exemplary logic flow for accepting city, state, zip (CSZ) lookup module results, in accordance with the principles of the present invention.

In particular, a CSZ lookup module is used to search spatial indices for full or partial matches to search terms. CSZ results comprise a score, a latitude, and a longitude for each record. CSZ results always contain one of the following data sets: (city, state, postal code), (city, state), or (state). A country data set can be included if appropriate.

The search index in the global single search system contains different types of data from several different vendors. Consequently, the present invention requires a method of query specialization to provide hinting wherever possible. For instance, specialization for the suggestion functionality comprises a determination of whether or not a token in input text 810 (i.e. text input to the single search box global 110) contains a leading digit. When input text 810 (i.e. text input to the single search box global 110) contains a leading digit, a suggestion query is sent to the single search server 500 to examine specific street ranges in stored data, and other primary_text matches. Suggestions are provided in real time. Therefore, a user may easily add specificity to a search before selecting a result.

For general searches (e.g. searches initiated by pressing the search button), logic is a bit different and geocode is used freely as needed.

In accordance with the principles of the present invention, category filters available for searching a POI include: a category filter for searching by name and a category filter for searching by category code. The global single search system uses an existing category search code (used in searchbuilder 540) to identify POI category name matches in a search query.

In particular, each category name is mapped to a server ‘X’ code on the single search server 500. When a category code is sent from the single search client 550 to the single search server 500, the single search server 500 maps the category code received from the single search client 550 (in client ‘A’ code) to server ‘X’ code, in accordance with a scheme specified by the single search client 550. Once server ‘X’ code is obtained, the single search server 500 sends the category code to the Apache Solr™ search engine 560 to retrieve a requested number of matching POI records.

In accordance with the principles of the present invention, the global single search system filters gas price search queries by keyword (e.g. ‘fuel’) or by brand name (e.g. ‘chevron’). Keywords and brand names are detected in a category_keyword filter. Special handling exists to proxy a search query to the proxpoi servlet 520 for access to gas feed data.

In accordance with the principles of the present invention, the global single search system supports several types of single search.

In particular, the global single search system supports address search for all supported countries. In accordance with the principles of the present invention, a search query to initiate a search for an address contains a full address (i.e. street number, street name, city, state, and zip), a partial address (i.e. any one or more address parts), and/or an intersection.

Intersections are embedded in a search query in either of the following formats:

1. street name 1 & street name 2

2. street name 1 and street name 2

City, state, and zip are optional items in an intersection search query. For example, ‘Aliso Creek and Alicia Parkway’ is a valid intersection search query, as is, ‘Sand Canyon & Alton, Irvine, CA’. If no city or state name is provided in an intersection search query, then the single search system only searches for local intersection matches.

The global single search system may be used to search for a city name, a state or province name (depending on the country), and/or a particular country name.

In accordance with the principles of the present invention, the global single search system additionally supports search for a POI about a specific location. A search query to initiate a search for a POI about a specific location contains a location reference.

The global single search system supports the following location references: address references (e.g. ‘Walmart Laguna Niguel’), landmark references (e.g. ‘Starbucks Yankees Stadium’), airport references (e.g. ‘Starbucks JFK’ and ‘Starbucks La Guardia Airport’), and contact's address references (e.g. ‘Macy's near John’, where ‘John’ is a contact).

In accordance with the principles of the present invention, an address reference contains one or more of the following components (in any combination): a city reference (e.g. ‘Walmart Laguna Niguel’ and ‘Book Stores Aliso Viejo, CA’), a state/province reference (e.g. ‘Museums CA’ and ‘National Parks Yorkshire’), a country reference (e.g. ‘Beaches Thailand’ and ‘National Parks Argentina’), and/or a postal code. For example, ‘Borders in Aliso Viejo, CA’ and ‘McDonalds 92656’ are both examples of search queries with valid address references. When a city and state name are embedded in a user search query with other search terms (with or without separator keywords), the single search server 500 centers search on the geocoded city center of the city and state name and performs a search operation on the other search terms. Likewise, when a city name is embedded in a user search query with a POI or POI category search term (with or without separator keywords), the single search server 500 searches for the POI or POI category and treats the city name as additional search criteria.

In accordance with the principles of the present invention, an airport reference contains an airport name and/or an airport code. A contact's address reference may contain a partial contact name. If a contact's address reference yields multiple matching contact names, and/or if multiple addresses are stored for a matching contact name, then the global single search system prompts a user to select an option from a set of potential options.

A search operation excludes words in a search query that identify a location reference. For example, search query ‘walmart near Irvine CA’, prompts the single search server 500 to identify location reference, ‘Irvine, CA’, and search ‘walmart’. The word ‘near’ is dropped from both the geocode and the search query.

In accordance with the principles of the present invention, the global single search system supports search for a POI or a POI category within a particular city, when a city name is entered in front of a POI or POI category name (e.g. ‘Anaheim Burger King’ and ‘Anaheim Car Rental’) in a search query, or after a POI or POI category name (e.g. ‘Burger King Anaheim’ and ‘Car Rental Anaheim’) in a search query. The global single search system does not support search for a POI or a POI category within a particular city, when a city name is entered in the middle of a POI or POI category name (e.g. ‘Burger Anaheim King’ and ‘Car Anaheim Rental’) in a search query.

Location references are preferably limited to city, state/province, zip, country, or any combination thereof. For example, search queries, ‘sofitel san carlos, CA’, ‘sofitel san carlos’, and ‘sofitel 92656’ all contain valid location references. The global single search system does not support street names or street numbers in a location reference.

The present invention tolerates location references with minor spelling errors (e.g. ‘sofitel hotel san carrlos ca’). However, support for spelling errors is limited. Approximately only 2 character misspellings are supported for a location reference (a function of the misspelling method). At a minimum, spelling correction supports country names, state names, state capitals, country capitals, cities with large populations, and popular cities. Spelling correction supported within the present invention recognizes misspellings and does not return too many unwanted results.

In accordance with the principles of the present invention, the global single search system implements a new location reference extraction method for identifying location references in a search query. The inventive location reference extraction method supports multiple countries and multiple languages.

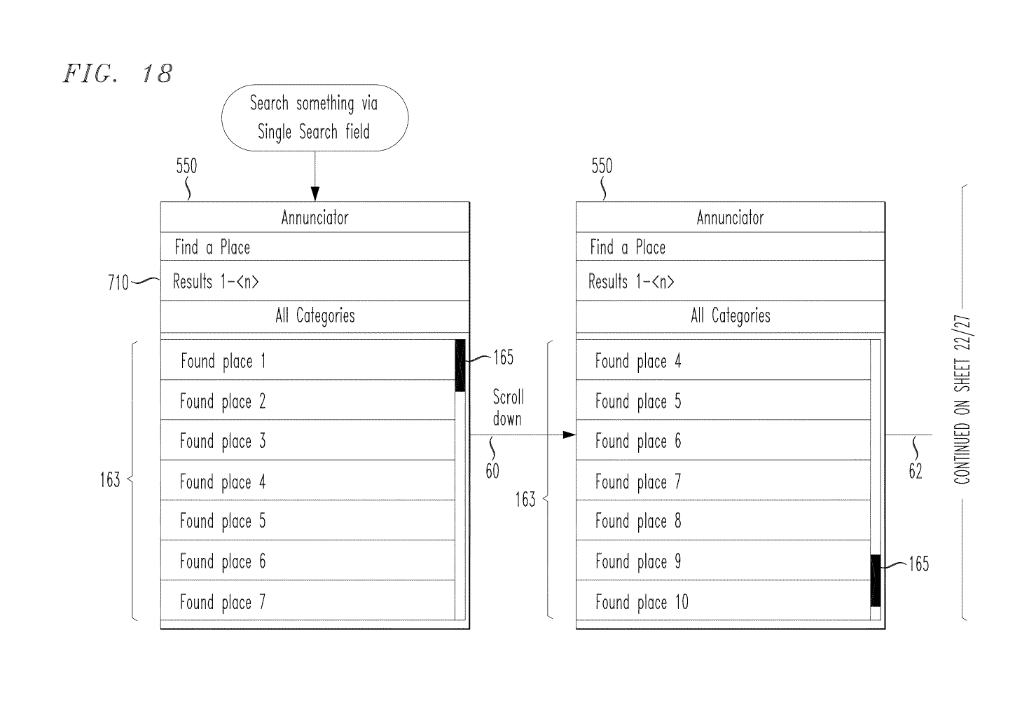

FIG. 17 depicts an exemplary flow diagram for identifying location references in a search query, in accordance with the principles of the present invention.

As depicted in FIG. 17, the single search server 500 first searches a search query for a separator word (e.g. ‘in’, ‘near’, ‘at’, and ‘around’). As shown in step 81, if the single search server 500 identifies a separator word in query text, then the single search server 500 performs a location reference lookup on query text to the right of the separator word.

To perform a location reference lookup, the single search server 500 first searches query text for a possible zip token. In accordance with the principles of the present invention, a zip token cannot be the first token in a search query unless that zip token is the only token in the search query.

Following zip search, the single search server 500 sends a query to the SOLR server 560 to initiate a search for location matches, e.g. city, state, zip, etc.

During a location reference lookup, the single search server 500 initiates the following variables: g_city, g_city_saved, g_state, and g_zip. Variable g_city_saved is reserved for a first city found.

For each search result, if doc_type=city, and an exact match (not a partial match) for that city is identified in query text, then that search result is saved in variable, g_city. The global single search system additionally saves the city position in the search query and the city token position in the search query for that city match. For example, if a city token begins at a 4^{th} token in a search query, then that city token has a city token position value of 3.

If more than one city result is an exact match for a search term in query text, then the single search server 500 stores the rightmost city match to variable, g_city. For example, the single search server 500 differentiates between city matches, ‘San Francisco’ and ‘Francisco’ to determine a most relevant city match.

The single search server 500 then implements the same tasks performed for doc_type=city, for doc_type=state and doc_type=zip.

When search for city, state, and zip tokens in query text is complete, the single search server 500 saves the leftmost city token identified in query text to variable, g_city_saved.

If, after checking all SOLR results, it is known that tokens in query text to the right of variable, g_city, are not state, country, or zip tokens, then either g_city_saved is identified as a location reference in the search query, or no location reference is identified in the search query.

Moreover, if variable, g_city_saved, does not correspond to the first token in the search query, then the single search server 500 must assure that all tokens to the left of g_city_saved are location references, e.g., state, zip, etc. If all tokens to the left of g_city_saved are not identified as location references, then no city location reference is identified for that search query.

The global single search system supports location references positioned in the front or the back of a search term, but not in the middle of a search term.

If a location reference is identified in the search query, the single search server 500 validates variables: g_city, g_state, and g_zip, and assigns output priority in the following order: zip, city, state.

As depicted in step 85, if a location reference is identified in query text to the right of the separator word, then the single search server 500 sends an HTTP search query to the SOLR server 560 for search results based on query text to the left of the separator word. Single search is centered on the location reference identified in the search query.

As shown in step 87, if a location reference is not found in query text to the right of the separator word, then the single search server 500 sends an HTTP search query to the SOLR server 560 requesting search results based on the entire search query.

In step 83 of FIG. 17, if the single search server 500 does not find a separator word in query text, then the single search server 500 performs a location reference lookup on the entire search query. A location reference lookup is performed on the entire search query in the same manner that the location reference lookup is performed on query text to the right of the separator word (as previously described in step 81). In step 89, if no location references are identified in query text, then the single search server 500 sends an HTTP search query to the SOLR server 560 for search results based on the entire search query.

Alternatively, if the single search server 500 does detect at least one location reference in query text (step 91), then the single search server 500 determines a specific number of location references identified in the search query. As shown in step 95, if the single search server 500 identifies two or more correlated location references (location references must be correlated) (e.g. city+zip, city+state, zip+state, or any other combination) (step 14) in the search query, then the single search server 500 separates the search query in to the following two attributes: keyword (i.e. query text minus location reference(s)) and point (i.e. a point corresponding to correlated location references). The single search server 500 subsequently sends an HTTP single search query to the SOLR server 560 requesting search results relevant to the keyword attribute, centered about the point attribute.

As depicted in step 93, if only one location reference is identified in query text, the single search server 500 attempts to classify the location reference as a zip code, a state, a country, a major city (as determined by population), or a city close to a requesting client/user device As shown in step 99, if the location reference can be classified as a zip, a state, a country, a major city, or a city nearby then the single search server 500 separates the search query in to attributes: keyword (i.e. query text minus the location reference) and point (i.e. point of the location reference). The single search server 500 then sends an HTTP single search query to the SOLR server 560 for search results relevant to the keyword attribute, centered about the point attribute.

As depicted in step 97, if the single search server 500 is not able to classify the location reference as a zip, a state, a country, a major city, or a city nearby, then the single search server 500 sends an HTTP single search query to the SOLR server 560 for search results based on the entire search query.

In accordance with the principles of the present invention, the global single search system also supports search for a POI without a location reference. A search query to initiate a search for a POI, without a location reference, includes a full POI name (e.g. ‘in-n-out burger’), a partial POI name (e.g. ‘Bellagio’ for ‘Bellagio Hotel and Casino’), a POI name with a minor misspelling (e.g. ‘Bellagio’ for ‘Belagio Hotel and Casino’), a POI name with words in an incorrect order (compared to the actual POI name) (e.g. ‘studios universal’ for ‘universal studios hollywood’), a single-word POI name expressed as split words (e.g. ‘pink berry’ for ‘pinkberry’), a multi-word POI name expressed as a single word (e.g. ‘toysrus’ for ‘Toys ‘r’ us’), a POI name expressed as an acronym (e.g. ‘dm’ for ‘Department of Motor Vehicles’ and ‘moma’ for ‘Museum of Modern Art’) a popular brand (e.g. Starbucks, McDonald's) and/or a POI category (e.g. ‘Department Stores’).

When no location reference is embedded in a search query, the global single search system defaults to searching about a current location of a requesting client/user device. In accordance with the principles of the present invention, search based on a current location of a requesting client/user device is prioritized according to country. For instance, surrounding borders (e.g. the Mexican border, the Germany border, etc.) must be taken in to consideration before search results are returned to the single search client 550. If a current location is unavailable, the global single search system searches about a last known location of a requesting client/user device.

In accordance with the principles of the present invention, the global single search system additionally supports search for a POI belonging to a specific category. A search query to initiate a search for a POI belonging to a specific category contains a category name. Primary category names (e.g. ‘Pharmacies’) and secondary category names (synonyms) (e.g. ‘Sporting Goods, Decatur, IL’) are supported within the present invention. For example, ‘Chinese Restaurants’ is an exemplary primary category name and ‘Chinese Food’ is an exemplary synonym for that primary category name. Query reformulation requirements apply to POI category queries. Matching is tolerant to limited user input error. The global single search system supports category names in all supported languages.

In accordance with the principles of the present invention, both a POI name and a POI category may be embedded in a user search query. For example, ‘Avis Car Rental’ is an exemplary search query with POI and category intent (‘Avis’ is the POI name and ‘Car Rental’ is the category name).

The global single search system also supports search for a popular brand. A search query to initiate a search for a POI affiliated with a popular brand contains a popular brand name, e.g., Starbucks, McDonald's, etc. In accordance with the principles of the present invention, search for a popular brand is handled much like category search.

In accordance with the principles of the present invention, the global single search system additionally supports contacts search, favorites search, and recent searches search. However, contacts search, favorites search, and recent searches search all operate solely on the client side. Therefore, any contacts, favorites, and/or recent searches matching supplied search criteria are presented on the single search client 550 as search suggestions only.

The global single search system also supports search for landmarks in all supported countries.

Moreover, the global single search system preferably supports various popular search terms, abbreviations, and common misspelling for well-known points of interest (POI). For example, a search query to initiate a search for a Verizon wireless store may contain any one or more of the following search terms: ‘Verizon Wireless’, ‘Verizon Wireless Stores’, ‘Verizon Wireless Store’, ‘VZW’, ‘VZW Stores’, ‘VZW Store’, ‘Verizon’, ‘Veirzon’, ‘Veriozn’, ‘Verizon Stores’, and ‘Verizon Store’.

In accordance with the principles of the present invention, the global single search system also supports road side assistance search. In particular, a search query to initiate a search for road side assistance contains one or more of the following search terms: ‘road side assistance’ and ‘help’.

The global single search system also supports along-my-route searches for POIs, only. An along-my-route search for POIs is defined as follows:

1. Matching POIs must be directionally ahead of a current location of a requesting client/user device.

2. Matching POIs must be within a 1 mile corridor of a searched route.

3. Matching POIs must be no more than 1 mile past a destination of a searched route.

In accordance with the principles of the present invention, the search servlet 510 uses SOLR 560 to perform along-my-route searches (both user-generated and fastpoi).

The global single search system additionally supports airport search. In particular, the global single search system supports search for commercial airports in all supported countries (i.e. a user may search for an airport nearby) and search for non-commercial airports by airport name or airport code. A search query to initiate a search for an airport contains an airport name, an airport code, an airport category, and/or an airport city (e.g. ‘Newark Airport’).

Airport search may be performed via geocode or via SOLR. To initiate an airport search via geocode, keyword, ‘airport’, must be embedded in a search query. Alternatively, keyword ‘airport’ need not be embedded in a search query to initiate an airport search via SOLR, since the global single search system boosts all commercial airports. For example, when search query, ‘john wayne’, is entered in to the single search box global 110, a search result for ‘John Wanye Airport’ is returned to the single search client 550, even when a requesting client/user device is located far away from John Wayne Airport.

The global single search system also supports gas station/gas price search. In accordance with the principles of the present invention, a search query to initiate a search for a gas station/gas price item contains a gas station/gas price keyword. For example, keyword ‘GAS’ triggers a search for a gas POI when entered in to the single search box global 110. The present invention treats a search query comprising any one or more of the following search terms as a gas station/gas price search query: gas, gasoline, petrol, fuel, chevron, arco, BP, exxon, valero, texaco, 76, conoco, rotten robbie, and AM PM and AM/PM. This list of keywords is configurable on the single search server 500 and all query reformulation rules apply. The global single search system support gas station/gas price keywords in every supported language.

A user may use separator words and punctuation marks in a search query to demarcate a POI reference sub-string from a location reference sub-string. The following separator words and punctuation marks are supported within the present invention: ‘in’, ‘near’, ‘at’, ‘around’, ‘,’, ‘;’, and ‘:’. For example, ‘Walmart in Laguna Niguel’ is a valid search query containing a separator word.

Table 1 includes a list of additional separator words supported within the global single search system.

TABLE 1

| | | |
|---|---|---|
| Canada | English/French | around/autour, at/à, in/ |
| | | en, near/près |
| Puerto Rico Mexico Spain | Spanish | cerca de, en, alrededor |
| Argentina Chile Venezuela | | de, por |
| Colombia Dominican | | |
| Republic Peru | | |
| Germany Liechtenstein | German | um, bei, in, nahe |
| Austria | | |
| France | French | autour, à, en, près |

For purposes of matching, the global single search system ignores stop words ‘a’, ‘an’, ‘the’, and ‘by’ (e.g. Courtyard by Marriott) embedded in a user search query. Stop words, as a concept, exist so that search engines can ignore terms that are insignificant in a search query, due to commonality. A stop word is insignificant in a search query, when other words embedded in that search query provide meaningful context to a search. In accordance with the principles of the present invention, the single search client 550 transmits a suggestion query when a user inputs stop words in to the single search box global 110. The list of stop words provided herein is localizable, easily adaptable, and configurable on the single search server 500.

In accordance with the principles of the present invention, the global single search system is tolerant to the presence or absence of special characters in a search query. For example, search queries, ‘Jo-Ann’ and ‘Joann’ both yield search result ‘Jo-Ann Fabric & Craft Stores’ (‘&’ and ‘-’ are present in both the search queries and the POI name, respectively). Special characters are text characters that fall outside the range of [a-zA-Z0-9] (i.e. characters that fall outside the ranges ‘a’ to ‘z’ or ‘A’ to ‘Z’ or ‘0’ to ‘9’). The global single search system supports special characters for each language supported within the present invention.

The global single search system additionally tolerates minor misspellings of search query terms. In particular, the global single search system handles misspellings that do not cause a significant difference in a phonetic ‘sounds-like’ value of a word (e.g. ‘fone’ is close enough to ‘phone’), misspellings that consist of a transposition of two consecutive terms (e.g. ceiling and cieling or yellow and yellwo), and misspellings that consist of two closer keys (e.g. ‘mcdonalfs’ and ‘mcdonalds’, with f and d being the closer keys). For example, the global single search system correctly handles the following misspellings of search term, ‘Walmart’: ‘wlmart’, ‘wallmart’, ‘walmrt’, and ‘wlmrt’.

To provide tolerance for user input errors (e.g. incorrect spellings, words out of order, etc.), the global single search system attempts to normalize user search queries. For instance, search queries entered in to the single search box global 110 are insensitive to case. Therefore, upper or lower case text in a search query does not matter, except when assigning a relevance score. Search queries are additionally insensitive to singular (e.g. curve) and plural form (e.g. curves), (except when assigning a relevance score), and all variant forms (suffixes mostly) of a root word, as supported by the underlying search engine (i.e. Apache Solr™) (e.g. connection’, ‘connections’, ‘connective’, ‘connected’, and ‘connecting’ all yield ‘connect’ as a stem).

In accordance with the principles of the present invention, the global single search system normalizes data in to a single document format so that data may be searched from several different sources. Table 2 depicts an exemplary single document format used to build a generic search system within the present invention.

TABLE 2

| name | type | indexed | omitNorms | Stored | MultiValued | Required |
|---|---|---|---|---|---|---|
| id | string | TRUE | TRUE | TRUE | | TRUE |
| name | textstd | TRUE | TRUE | TRUE | | |
| name_stem | text | TRUE | TRUE | | | |
| doc_type | string | TRUE | | TRUE | | |
| signature | string | TRUE | | | | |
| primary_text | text | TRUE | TRUE | TRUE | TRUE | |
| suggest_edgen | edgytext | TRUE | TRUE | | TRUE | |
| grams | | | | | | |
| address_type | string | TRUE | | TRUE | | |
| airport | textCaseIgnore | TRUE | TRUE | TRUE | | |
| country | textCaseIgnore | TRUE | TRUE | TRUE | | |
| state | textCaseIgnore | TRUE | TRUE | TRUE | | |
| city | textCaseIgnore | TRUE | TRUE | TRUE | | |
| zip | textCaseIgnore | TRUE | TRUE | TRUE | | |
| street1 | textCaseIgnore | TRUE | TRUE | TRUE | | |
| street2 | textCaseIgnore | | | TRUE | | |
| streetnum | textCaseIgnore | | | TRUE | | |
| streetnum_min | tint | TRUE | | TRUE | | |
| streetnum_max | tint | TRUE | | TRUE | | |
| phone_country | string | | | TRUE | | |
| phone_area | string | | | TRUE | | |
| phone_num | string | | | TRUE | | |
| phone_ext | string | | | TRUE | | |
| phone_type | string | | | TRUE | | |
| category_code | textCaseIgnore | TRUE | TRUE | TRUE | | |
| category_list | textCaseIgnore | TRUE | TRUE | TRUE | | |
| naics_category | textCaseIgnore | | | TRUE | | |
| category_name | textAliased | TRUE | TRUE | TRUE | | |
| orig_category | string | | | TRUE | | |
| lat | tdouble | TRUE | | TRUE | | |
| lon | tdouble | TRUE | | TRUE | | |
| latlon | location | TRUE | TRUE | TRUE | FALSE | |
| pvid | string | FALSE | | TRUE | | |
| vendor_code | textCaseIgnore | FALSE | | TRUE | | |
| average_rating | tfloat | FALSE | | TRUE | | |
| rating_count | tlong | FALSE | | TRUE | | |
| tagline | string | FALSE | | TRUE | | |
| enhanced_pairs | string | FALSE | | TRUE | TRUE | |

As depicted in Table 2, different data sources have different data fields. Fields ‘id’ and ‘doc_type’ are required for every data record stored in the global single search system. Blank fields are inserted by an import process wherever data does not exist. An entry for province or the like may be included in the ‘name’ column of Table 2 if appropriate.

Table 3 portrays exemplary strings that are acceptable in a doc_type field.

TABLE 3

| | | | |
|---|---|---|---|
| | Primary Search | Secondary Search | |
| Value | Field(s) | Field(s) | Description |

| | | |
|---|---|---|
| POI | name | category list, city, |
| | | state, zip |
| AIRPORT | name, airport code | city |
| ADDRESS | street1, | city, zip, state |
| | streetnum_min, | |
| | streetnum_max | |
| VZW-POI | name, | city, state, zip |
| | category_code | |

In accordance with the principles of the present invention, to handle search requests for street names, the global single search system normalizes street names embedded in a user search query with respect to the following issues: street types (suffixes), cardinal directions, and ordinal street names. Search queries are normalized against source data at query time.

At query time, the present invention uses the following exemplary constructs to normalize street abbreviations embedded in a user search query: street-name-alias:
st:
   street
   saint
   st.
   str
   str.
ave:
   avenue
   ave.

For example, strings: ‘street’, ‘saint’, ‘st.’, ‘str’, and ‘str.’, embedded in a user search query are all mapped to street abbreviation ‘st’ at query time. Similarly, the present invention maps strings ‘avenue’ and ‘ave.’ embedded in a user search query to street abbreviation ‘ave’ at query time. Data normalization is provided for each street type found in Navteq RDF data.

When deemed appropriate, the global single search system uses the following exemplary constructs to normalize cardinal directions embedded in a user search query: directional-norms:
s:
   south
sw:
   southwest
   south west
se:
   southeast
   south east
n:
   north
nw:
   northwest
   north west
ne:
   northeast
   north east
w:
   west
e:
   east

Moreover, the global single search system uses existing ordinal mapping functions from map data team and/or geocode parsing to normalize ordinal strings embedded in a user search query. The global single search system maps from ordinal to text-only to benefit from sounds-like and phonetic methods. In accordance with the principles of the present invention, ordinal strings embedded in a user search query are normalized using the following exemplary constructs:

ordinal-street-norms:
first:
   1st
second:
   2nd
third:
   3rd . . .
twenty:
thirty:
etc . . .

A search query transmitted to the single search server 500 for relevant search results comprises the following elements: position, iter-command, search-filter, directed, route-corridor, and want-premium placement. The iter-command element and the search-filter element are both required in a search query, whereas position, directed, route-corridor and want-premium-placement elements are all optional and embedded in a search query in accordance with unique circumstances of a given search request.

In accordance with the principles of the present invention, a position element is included in a search query to represent a center of a proximity search. If the single search client 550 is able to obtain a current position of a requesting client/user device or a recent position of a requesting client/user device, then a position element comprising that current/recent position is embedded in a relevant search query. Only when a location fix is unavailable, may a position element be eliminated from a search query. Moreover, when performing an along-my-route search, the position element in a search query specifies a position on that route from which to start search. If a start position is not located on a searched route, then search begins from a point on that searched route, nearest the start position.

A directed element is included in a search query to optimize search in a particular direction of travel (as specified in a location reference).

In addition, a route-corridor element is included in a search query to enable an along-my-route search. A route-corridor element (if present in a search query) indicates that only POIs along a requested route should be displayed on the map screen 200, and for safety cameras along that route.

A route-id attribute is included in a search query to initiate a more general search of POIs along a route. In particular, a route-id attribute is embedded in a search query to request POIs in response to a find a place request.

A want-premium-placement element is included in a search query to request that a search response (i.e. a results set) contain a premium placement ad. When a premium placement ad is requested in a search query, an ad is returned in a corresponding results set, in addition to search items (specified in a ‘number’ attribute in the Iter-command element) requested for that single search. For example, if 10 local search items are requested for a single search, then a premium placement ad is returned to the single search client 550 as an 11^{th} item in a results set.

An iter-command element and a search-filter element are required elements in a search query. The iter-command element holds an iteration command for a search query and the search-filter element represents filter criteria. More particularly, the search-filter element specifies which attributes to search on and what information/details are required in a results set.

In accordance with the principles of the present invention, a single search is controlled by parameters of the search-filter element. Parameters of the search-filter element include: a result-style element and anywhere from 1 to n key-value pair elements.

In accordance with the principles of the present invention, the result-style element in the search-filter element restricts the amount of information displayed in a results set. If no result-style element is included in the search-filter element, then all information/details must be displayed in a results set. More particularly, the result-style element in the search-filter element comprises a key attribute (a string). The key attribute describes which of an available set of details to return to the single search client 550 for each search result. More particularly, the key attribute in the result-style element contains one of the following possible values: ‘suggest’ (i.e. a key attribute value used when sending a suggestion request to the single search server 500), ‘single-search’ (i.e. a key attribute value used when sending a single search request to the single search server 500), or ‘geocode’ (i.e. a key attribute value used by the single search server 500 to indicate that a search is based on a previous suggestion result, and should be geocoded directly).

A key-value pair element in the search-filter element contains attributes: key and value. A key attribute (a string) in a key-value pair element holds a name that describes data stored in the value attribute of that key-value pair element. The key attribute is used to lookup a corresponding key-value pair element from a list of key-value pair elements. Correspondingly, the value attribute (a string) in a key-value pair element holds data described by the key attribute in that key-value pair element.

In accordance with the principles of the present invention, a key-value pair element (in the search-filter element of a single search query) contains any one of the following four key attributes: ‘name’, ‘category’, ‘source’, or ‘search-result-id’.

When the key attribute in a key-value pair element is ‘name’ (i.e. a name key-value pair), the value attribute in that key-value pair element contains contents of the single search box global 110 (i.e. a user search query entered in to the single search box global 110). A full search (i.e. a single search) is invoked on the value attribute in the name key-value pair element, when the result-style element in the search-filter element of that search query, has key attribute, ‘single-search’.

Moreover, when the key attribute in a key-value pair element is ‘category’ (i.e. a category key-value pair), the value attribute in that key-value pair element contains a category code for a selected category (i.e. a category selected from a list of categories 410 on the single search client 550). The category key-value pair element is embedded in the search-filter element of a search query when a user selects a category to search from a list of categories 410 on the single search client 550. If a category key-value pair element is embedded in the search-filter element of a search query, then the name key-value pair element in that search-filter element contains a value attribute with no text. A category key-value pair element may be provided by the single search server 500 as part of a search-filter element of a previous suggest-match.

In accordance with the principles of the present invention, when the key attribute in a key-value pair element of the search-filter element is ‘source’ (i.e. a source key-value pair), the value attribute in that key-value pair element describes an activity that initiated a single search. Activity information is used to apply certain boosts, when applicable. For instance, when handling a suggestion query, the single search server 500 embeds the source value stored in the search-filter element of that suggestion query in each suggest-match returned to the single search client 550. The value attribute in a source key-value pair element contains any one of the following potential string values: ‘main-screen’ (used when a user initiates a single search from the main application screen, regardless of current view: map mode or carousel), ‘place-screen’ (used when a user initiates a single search from the find a place screen 400), or ‘address-screen’ (used when a user initiates a single search from the enter an address screen 300).

Further, when the key attribute in a key-value pair element in the search-filter element is ‘search-result-id’ (i.e. a search-result-id key-value pair), the value attribute in that key-value pair element contains an opaque identifier used by the single search server 500 to retrieve a specific search result, as determined by a previous suggestion query. The search-result-id key-value pair element is only included in a search query when provided by the single search server 500 in the search-filter element of a suggest-match. The single search client 550 does not manipulate a search-result-id key-value pair element value in any way. Rather, the single search client 550 simply passes a search-result-id key-value pair element back to the single search server 500, as is.

In accordance with the principles of the present invention, a search query additionally includes a scheme attribute and a language attribute. The scheme attribute (a string) holds a specific data scheme (e.g. ‘tcs-single-search’ scheme) to use for a single search. Moreover, the scheme attribute in a search query may be different from a standard proxpoi ‘scheme’, since it describes a specific collection of map data, as well as POI data and dynamic content providers.

The language attribute in a search query is an optional 2 to 5 character string that specifies a language to use for a single search. If a language attribute is not specified in a search query, then US English is used to carry out that single search (by default).

A search format used within the single search system determines a position of a client/user device, and then uses that position to return a distance value with each search result (to identify a distance between a client/user device and a search result).

The following depicts an exemplary search query template used to search non-suggestion queries, in accordance with the principles of the present invention.

(search-query (scheme tcs-single-search language
REPLACE_WITH_USER_LANGUAGE)

(position (variant point)

(point (lat |REPLACE_WITH_LATITUDE| lon
|REPLACE_WITH_LONGITUDE|)))

(position (variant geographic-position)

(geographic-position
(lat |REPLACE_WITH_LATITUDE| lon
|REPLACE_WITH_LONGITUDE|)))

(iter-command (state ″″ command start number |AAAABQ==|))
(search-filter ( )

(pair (value ″REPLACE_WITH_SEARCH_TERM″ key
name))
(pair (value “main-screen” key source))
(result-style (key single-search)))

(want-premium-placement)
(want-distance-to-user))

The following depicts an exemplary search query template used to search a suggested address or airport, in accordance with the principles of the present invention:

(search-query (scheme tcs-single-search language REPLACE_WITH_USER_LANGUAGE)

(position (variant point)

(point (lat |REPLACE_WITH_LATITUDE| lon |REPLACE_WITH_LONGITUDE|)))

(position (variant geographic-position)

(geographic-position

(lat |REPLACE_WITH_LATITUDE| lon |REPLACE_WITH_LONGITUDE|)))

(iter-command (state ″″ command start number |AAAABQ==|))
(search-filter ( )

(pair (value ″REPLACE_WITH_COMPLETE_TERM_FROM_SUGGESTION″ key name))
(pair (value “main-screen” key source))
(result-style (key geocode)))

(want-distance-to-user))

The following depicts an exemplary search query template used to search a suggested POI, in accordance with the principles of the present invention.

(search-query (scheme tcs-single-search language en-US)

(position (variant point)

(point (lat |REPLACE_WITH_LATITUDE| lon
|REPLACE_WITH_LONGITUDE|)))

(position (variant geographic-position)

(geographic-position (lat |REPLACE_WITH_LATITUDE| lon
|REPLACE_WITH_LONGITUDE|)))

(iter-command (state ″″ command start number |AAAABQ==|))
(search-filter ( )

(pair (value ″REPLACE_ME_WITH_ POI_NAME″ key
name))
(pair (value ″REPLACE_ME_WITH_ POI_CATEGORY″
key category))
(pair (value “main-screen” key source))
(result-style (key single-search)))

(want-premium-placement)
(want-distance-to-user))

The following depicts an exemplary search query template for suggestions with coordinate in point format, in accordance with the principles of the present invention.

(search-query (scheme tcs-single-search language en-US)

(position (variant point)

(point (lat |QEDHo0gC4uc=| lon |wF1uphGFEA4=|)))

(iter-command (state “” command start number |AAAABQ==|))
(search-filter ( )

(pair (value “irvine” key name))
(pair (value “main-screen” key source))
(result-style (key suggest))))

The following depicts an exemplary search query template with coordinate in GPS packed format, in accordance with the principles of the present invention.

(search-query (scheme tcs-single-search language en-US)

(position (variant gps)

(gps (packed |N7d7lgBfdUX+sSDxAX0AAAACAg==|)))

(iter-command (state “” command start number |AAAABQ==|))
(search-filter ( )

(pair (value “9 laguna hills” key name))
(pair (value “main-screen” key source))
(result-style (key single-search)))

(want-premium-placement))

The following depicts an exemplary search query template for an along-my-route search with specific string, in accordance with the principles of the present invention.

(search-query (scheme tcs-single-search language en-US route-id
|caC6RKhGQKmhJWhzD+ICHw==|)

(position (variant point)

(point (lat |QEDHo0gC4uc=| lon |wF1uphGFEA4=|)))

(iter-command (state “” command start number |AAAABQ==|))
(search-filter ( )

(pair (value “Walmart” key name))
(pair (value “” key category))
(pair (value “main-screen” key source))
(result-style (key single-search)))

(want-premium-placement ( )
(image (width |AAAAQA==| height |AAAAQA==| format png))))

The following depicts an exemplary search query template for an along-my-route search for fastPOI, in accordance with the principles of the present invention.

(search-query (scheme tcs-single-search language en-US)

(position (variant gps)

(gps (packed |N7d7lgBfdUX+sSDxAX0AAAACAg==|)))

(iter-command (state “” command start number |AAAABQ==|))
(search-filter ( )

(pair (value AE key category))
(pair (value ACC key category))
(pair (value AA key category))
(pair (value AH key category))
(pair (value AIE key category))
(pair (value AIC key category))
(pair (value AID key category))
(pair (value AKE key category))
(pair (value AFC key category))
(pair (value “main-screen” key source))
(result-style (key single-search)))

(want-premium-placement ( )
(image (width |AAAAQA==| height |AAAAQA==| format png)))
(route-corridor (distance |H24=| width |AfQ=| route-id
|R/p7RXqrRC6JIE67hffOpw==|)))

In accordance with the principles of the present invention, search results relevant to a user search query (i.e. a specified criterion) are retrieved by the search servlet 510 and returned to the single search client 550 in a search response. A search response may contain a mix of data (e.g. geocoded street addresses, landmarks, points of interest, etc.) from a multitude of data sources.

In accordance with the principles of the present invention, the global single search system uses the following data to generate search results for a search response: a search query, a current location of a requesting client/user device, a client product version, and a client device platform. The ‘scheme’ attribute in a search query controls which data is accessed for a particular client version and/or device platform.

Server-side result generation applies to addresses, POIs, POI categories, and airports. Client-side result generation applies to on-device data, i.e. favorites, contacts, and recent searches, and returns search suggestions, only.

Mixed results sets are supported within the present invention. For instance, a traditional POI, a fuel POI, and an address may all be combined as one single search result. A search result may include any type of POI match and any type of address match, including airports, Verizon (vzw) stores, gas prices, POIs enhanced with pictures, etc.

The global single search system attempts to classify each search query entered in to the single search box global 110. Query classifications include: address, POI name, POI category, airports, and unknown.

When a search query is classified as an address query, the single search server 500 returns a list of matching addresses to the single search client 550. In accordance with the principles of the present invention, the global single search system supports address search with a country limit and address search with no country limit.

In particular, address search with a country limit, limits address search to a country within which a requesting client/user device is located, unless a different country is specified in a search query. For example, when search query, ‘20900 Oakwood Blvd., Dearborn MI’ is entered in to the single search box global 110 on a client/user device located in Windsor, Canada, a matching address result is not found. Rather, a matching address result for search query, ‘20900 Oakwood Blvd., Dearborn MI’, entered in to the single search box global 110 on a client/user device located in Windsor, Canada, is only found when search term, ‘United States’, is appended to the end of the search query.

Alternatively, for address search with no country limit, the single search server 500 searches an entire database for each address query entered in to the single search box global 110, unless a particular country has been specified in an address query. For example, when address search with no country limit is performed for search query, ‘20900 Oakwood Blvd., Dearborn MI’, entered in to the single search box global 110 on a client/user device located in Windsor, Canada, a matching address result in Dearborn, Mich. is found.

When generating result candidates, a current location of a requesting client/user device is taken into consideration to help disambiguate a search query. When searching for address results, the global single search system preferably progresses from address search limited to a country in which a requesting client/user device is located, to address search with no country limit. Address results are returned to the single search client 550 in order of increasing distance from a requesting client/user device.

A partial address may be entered in to the single search box global 110 to initiate a search on that address part. For instance, the global single search system returns relevant search results for a search query with a city name location reference, but no state/province or country name location reference (or abbreviation) (i.e. a partial address). For example, if search query, ‘Paris’ is entered into the single search box global 110, the global single search system may determine that a user is likely searching for Paris, France and not Paris, Tex., even when a requesting client/user device is located closer to Paris, Tex.

In accordance with the principles of the present invention, an address result contains the following details: street number (or range), street name, city, state, zip code, distance, and a mailbox graphic (to indicate that the result is an address). The mailbox graphic is optional and dependent on the user experience (UX) design of a results screen 710.

Search results displayed on a map screen for city, state, or country name searches are preferably displayed at an appropriate zoom level. For example, when address query, ‘Russia’, is entered in to the single search box global 110, a search result for the entire country of Russia is preferably returned to the single search client 550. The single search client 550 may then display the search result for the country of Russia on the map screen, which requires a high level of zoom. Moreover, when address query, ‘Liechtenstein’, is entered in to the single search box global 110, a search result for the entire country of Liechtenstein is preferably returned to the single search client 550. The single search client 550 may then display the search result for the country of Liechtenstein on the map screen, which requires a higher level of zoom than that used to display Russia.

Search results for city, state/province, and country searches preferably include bounding box information (e.g. extended pairs). Bounding box information is used to ensure that search results for cities, states, provinces, and countries are displayed on the map screen at a best possible zoom. When a map view of search results is panned and new results are fetched, the map on the screen does not pan to accommodate new search results. Only search results within a bounding box on a current map screen are displayed.

The global single search system preferably supports interfaces that permit all search results to be displayed on a map at the same time (regardless of locality) and interfaces that display search results on a map one at a time (e.g. when search results are spread far apart (in terms of distance)).

In accordance with the principles of the present invention, when a search query maps directly to a city name that is common to multiple cities (e.g., when the search button is selected while there are multiple cities in a search suggestion list 800) only one city result is returned in a search response. In accordance with the principles of the present invention, a city result returned to the single search client 550 is selected based on a combination of location and relevance criteria (i.e. information stored in relevance data sets).

In accordance with the principles of the present invention, if the single search server 500 returns multiple cities in a search response, then it is possible that a map screen displaying search results will have to display two cities that are very far away from one another (which does not provide a best user experience). For instance, if multiple city results are returned for search query, ‘Paris’, then a map screen displaying search results must zoom out to display both Paris, France and Paris, Tex., which is not ideal. Alternatively, when only one city result is returned in a search response, POI results corresponding to that one city may be returned therewith. When displaying search results on a map screen, the single search server 500 preferably returns only one city result and POI results corresponding to that one city result.

Moreover, when a state/province search yields multiple result candidates, priority is given to the state/province result that is most popular, unless there exists a state/province result located in the same region as a center point of search. If there exists a state/province result located in the same region as a center point of search, then that search result is given priority. State/province results located in the same region as a center point of search take priority over city results located in the same region as a center point of search, as long as such city results are not stored in the popular/major cities data set. In addition, state/province results not located in the same region as a center point of search take priority over city results not located in the same region as a center point of search, when city results are not stored in the popular/major cities data set. Country results take priority over city and state/province results not stored in the popular/major cities data set.

When a search query is classified as a POI name query, the single search server 500 returns a list of matching POIs to the single search client 550. POI name searches are not subject to a limited search boundary.

A POI result contains the following details: POI name, POI address (street number, street name, city, state, and zip code) (with up to 2 lines of display), distance from a center point of search, picture (if available), POI rating (i.e. a star rating) (if available), and a pin graphic (to indicate that the result is a POI).

POI ratings and pin graphics are optional and included in a POI result depending upon the user experience (UX) design of a results screen 710.

Fetching and rendering a picture for a POI result does not block display of the rest of the results screen 710.

POI search results are displayed on the single search client 550 in such a way that POIs located on the opposite side of a border (from a center point of search) may be visually differentiated from POIs located on the same side of a border (as a center point of search). For example, when search query, ‘McDonald's’ is entered in to the single search box global 110 on a client/user device located in San Ysidro, near the Mexican border, search results and search suggestions for McDonald's located across the Mexican border are visually differentiated from search results and search suggestions for McDonald's located on the US side of the Mexican border.

In accordance with the principles of the present invention, when a search query maps directly to a POI name with a city name that is common to multiple cities, the single search server 500 only returns POI results for one city to the single search client 550. In this case, a city result is selected based on a combination of the following: an exact city match for results within 100 miles of a requesting client/user device, an exact city match from relevance datasets, a close city match within 100 miles of a requesting client/user device, and an exact city match beyond 100 miles of a requesting client/user device (as long as the exact city match is beyond 100 miles of a requesting client/user device is not the same as an exact city match from relevance datasets). For example, when search query, ‘Starbucks Springfield’ is entered in to the single search box global 110 on a requesting client/user device located in Atlanta, Ga., the single search server 500 preferably returns search results for Starbucks, using Springfield, Va. as a center point of search, since Springfield, Va. is a best city name match. A predetermined radius is preferably used to determine a center point of search when a search query matches 2 cities with the same name, and the larger city is located farther away than the smaller city. The global single search system also preferably employs a method of determining a center point of search for a requesting client/user device that is located directly between two cities with the same name. In accordance with the principles of the present invention, popular cities (i.e. cities with populations larger than a predetermined threshold or cities that are popular tourist destinations) are given priority over smaller, less important cities that are closer to a requesting client/user device.

Moreover, when a search query maps directly to a city, state, province, or country name, and additionally maps directly to a POI name or a partial POI name, then the single search server 500 returns search results for city/state/province/country name matches first, followed by search results for POI name matches (exact or partial) sorted by distance. In particular, the single search server 500 initially searches for city, state, province, and country name matches first, and then performs a radius search for exact or partial matching POIs. If a first match is a city, country, or state name, then the single search server 500 only returns a search result for that city, country or state.

When a search query is classified as a POI category query, the single search server 500 returns POI items (ordered by increasing distance from a current location of a requesting client/user device or a center of search) stored in a matching POI category to the single search client 550. A POI category query is a search query that maps directly to a POI category name (or a pre-defined category alias). For example, search query, ‘Japanese Restaurants’ is classified as a POI category query, when ‘Japanese Restaurants’ is a name of a category.

The single search server 500 parses a search term embedded in a user search query to determine if that search term matches a POI category name. When a search query maps directly to a POI category name (or a pre-defined category alias), the single search server 500 treats that search query as a category code. The single search server 500 then queries the search engine using the category code, rather than the user search query, so that all results returned to the single search client 550 are members of the searched POI category.

Search results for a POI category query are displayed in order of relevancy, from high relevancy to low relevancy, depending upon what category is selected. In accordance with the principles of the present invention, a category search screen (Restaurants and etc., except airports) is a single search box global 110.

In accordance with the principles of the present invention, when a search query is categorized as a major brand query, the single search server 500 returns major brand items (ordered by increasing distance from a current location of a requesting client/user device or a center point of search) stored in a matching major brand category to the single search client 550. A major brand query is a search query that maps directly to a major brand name.

When a search query includes a state or city location reference and a search term (e.g. ‘Texas Barbecue’ and ‘Chicago Pizza’) that may pass for a POI name or a POI category name, the global single search system employs a combination of matching and distance criteria to determine search results. For example, when search query, ‘Chicago Pizza’ (both a POI name and a POI category name with a location reference) is entered in to the single search box global 110, the single search server 500 preferably returns individual POI results (if there is at least one POI result within a reasonable distance of a center point of search) to the single search client 550, along with search results for pizza restaurants located in Chicago (if there are a limited number of matching POI results within a reasonable distance of a center point of search).

When a search query is classified as an airport query, the single search server 500 returns a list of matching airports to the single search client 550. In particular, the single search server 500 preferably returns a list of global commercial airports to the single search client 550, in order of increasing distance from a requesting client/user device or a center point of search. Airport search is preferably filtered so that only commercial airports are returned to the single search client 500 when search query, ‘Airports’, is entered in to the single search box global 110. Airport searches are not subject to a limited search boundary.

When a search query is classified as a gas station/gas price query, the single search server 500 returns a lowest gas price for regular gasoline grade, an average gas price for regular gasoline grade, and matching gas stations to the single search client 550. Each gas station result comprises the following data: gas station name, street address, city, state, ZIP, phone number, price of regular gasoline grade, and distance from center point of search. The single search client 550 displays gas price data in a results set instead of a ‘star’ rating when single search results contain gas stations with price information.

A fuel-price-summary element is returned in a results set when all results generated by the single search server 500 are gas stations, or when a user has initiated a gas price search (i.e. via a proxpoi query 606) on the single search client 550.

Moreover, for an along-my-route search, the single search server 500 returns only certain POIs to the single search client 550. In particular, during an along-my-route search, the global single search system is optimized to quickly return a subset of POIs for navigation maps. POI items returned for an along-my-route search are filtered to ensure that a requested number of POIs are evenly distributed along a specified distance.

In accordance with the principles of the present invention, search results are ordered by total relevance (i.e. a function of text relevance and location relevance), including distance. Most often search results are ordered by increasing distance from a current location of a requesting client/user device.

In accordance with the principles of the present invention, the following criteria may ‘boost’ a relevance factor awarded to a result item: exact match (i.e. search query==POI name), exact case, words in search query in same order as words in candidate result item, special characters in search query present in candidate result item, diacritical marks in search query present in candidate result item, and inclusion of candidate result item in a preferred category. Candidate result items in certain preferred categories are awarded a higher relevance score than candidate result items in other non-preferred categories.

The global single search system also applies a boost method to global and regional brands. In accordance with the principles of the present invention, the boost method awards a higher boost to global brands, and considers location when applying boosts to regional brands. For example, the global single search system always boosts global brand, McDonald's, regardless of a location of a requesting client/user device. Alternatively, regional brand, In-N-Out Burger, is boosted more when a client/user device is located in California, and not boosted when a requesting client/user device is located far away from an In-N-Out Burger. For example, a client/user device located in California sees ‘In-N-Out Burger’ in a suggestion list when input text 810, ‘In’, is typed in to the single search box global 110. However, a client/user device located in Boston, Mass. only sees ‘In-N-Out Burger’ in a suggestion list when most or all of the characters of ‘In-N-Out Burger’ are typed in to the single search box global 110. In accordance with the principles of the present invention, boosts are also applied to global landmarks.

In accordance with the principles of the present invention, the global single search system analyzes data regarding border friendliness to appropriately boost search results in neighboring countries. In particular, the global single search system differentiates between borders that are easy to cross (i.e. friendly borders) and borders that are more difficult to cross (i.e. unfriendly borders), and then applies boosts/adjusts search criteria based on a requesting client/user device's proximity to such borders. Exemplary friendly borders include borders between most European countries (many citizens cross the borders between European countries quite easily and frequently). Crossing the border from Mexico to the United States is an example of an unfriendly border crossing (i.e. a border that is more of a hassle to cross).

In accordance with the principles of the present invention, the global single search system does not specifically rule out POIs on the other side of an unfriendly border, but rather awards a higher priority to POIs located on the same side of an unfriendly border (as a requesting client/user device). When a search query includes a POI name but no city name, the global single search system applies a negative boost to POIs located on the other side of an unfriendly border and applies a smaller negative boost, or no negative boost, to POIs located on the other side of a friendly border.

In accordance with the principles of the present invention, search queries that are exactly one word long yield search results with POI names that contain this one word. All other relevance criteria being equal, search results with POI names that exactly match a search query are awarded a higher relevance score. For example, for user search query, “mcdonald's”, search result, “McDonald's”, is awarded a higher relevance score than search result, “McDonald's Corporate Office”

Moreover, a multi-worded search query yields search results with POI names that include one or more words embedded in that user search query. All other relevance criteria being equal, the more words a POI name has in common with a search query, the higher the relevance score awarded to that POI item. Further, search results that have POI names with words in the same order as a user search query are awarded a higher relevance score.

The global single search system preferably returns a maximum of 100 search results for a search query. The single search client 550 is able to request up to 10 (configurable) search results at a time. If more than 10 search results are available for a search query, then an existing continuous scroll model is used to display results on a single page.

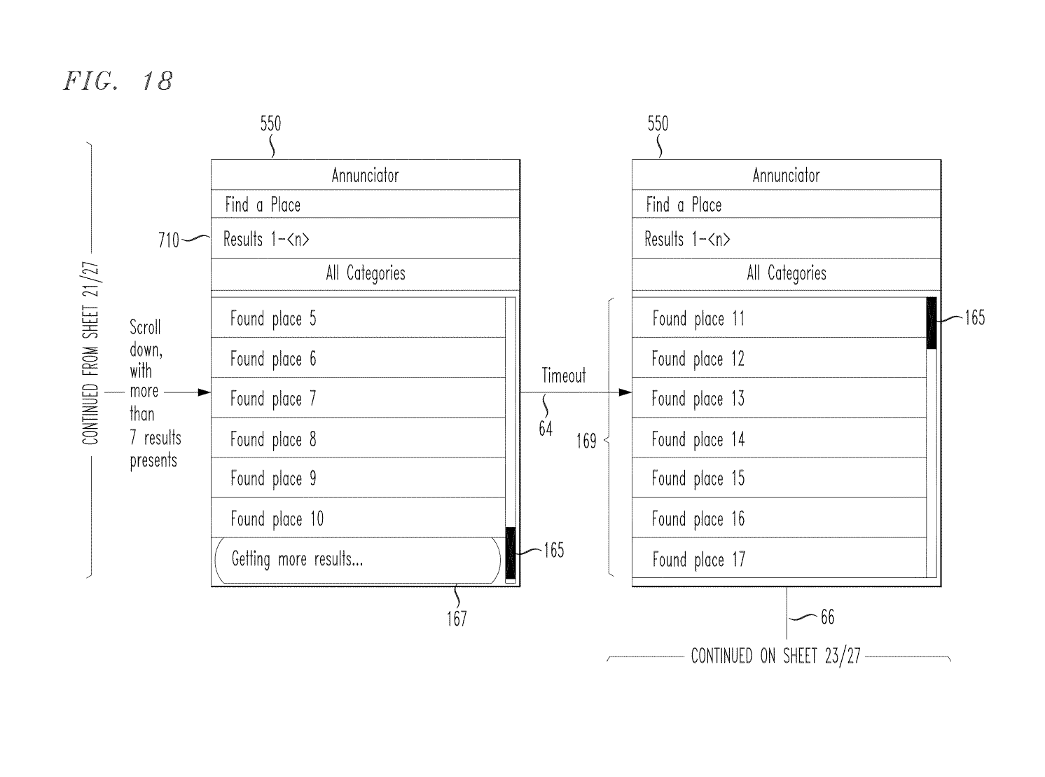

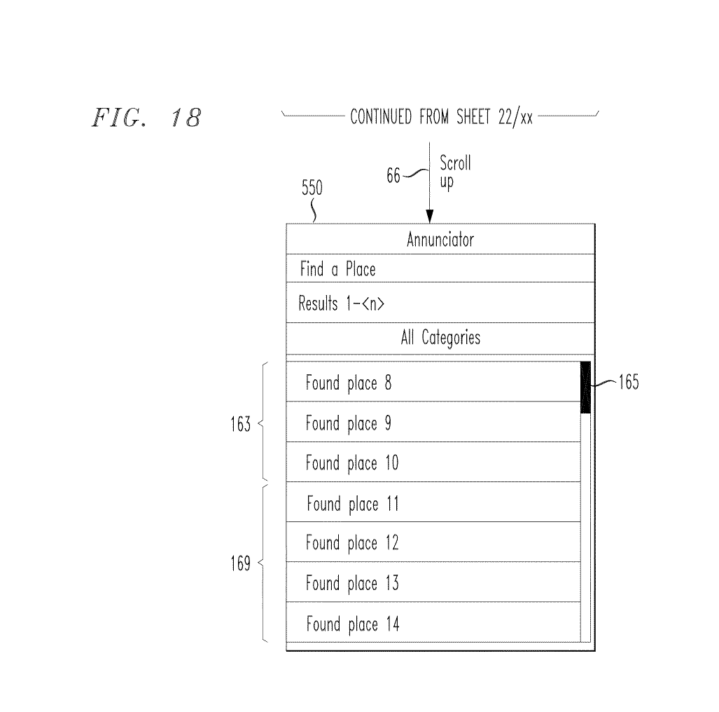

FIG. 18 depicts exemplary behavior of search results on the single search client, in accordance with the principles of the present invention.

As depicted in FIG. 18, the single search client 550 does not support pagination. Instead, search results are presented on a single page with a scroll 165. Initially, up to 10 search results (plus ads) 163 are fetched and presented on a results screen 710. As shown in step 60 of FIG. 18, the scroll 165 on the results screen 710 scrolls down to display all 10 search results 163.

As portrayed in step 62 of FIG. 18, when a user scrolls down and reaches the bottom of a results list, the single search client automatically fetches a next set of 10 search results from the single search server 500. While the single search client 550 is waiting for the single search server 500 to return a next set of search results, the single search client 550 displays an informational message (e.g. “Getting more results . . . ”) 167 at the bottom of the results screen 710. Once search results are returned to the single search client 550, the informational message (e.g. “Getting more results . . . ”) 167 is removed from the results screen 710 and the new set of search results 169 is appended to the previous set 163 displayed thereon, as shown in step 64. As depicted in step 66, the scroll 165 on the single search client 550 scrolls up and down to display all search results (163 and 169). The single search client 550 continues to respond to user actions, e.g., scroll, item selection etc., while waiting for a next set of search results to be returned.

To promote client responsiveness, the single search client 550 preferably pre-fetches a next set of up to 10 search results (and up to 1 advertisement), and holds these results in a client-side cache. For example, 20 search results are initially fetched for a single search, even though only 10 search results 163 are initially displayed on the results screen 710.

A search response for a single search contains the following elements: iter-result, proxmatch, suggest-match, file, and fuel-price-summary. In accordance with the principles of the present invention, an iter-result element is required in a search response, whereas proxmatch, suggest-match, file, and fuel-price-summary elements are all optional and included in a search response in accordance with unique circumstances of a given single search.

A search response contains anywhere from 0 to n proxmatch elements. Each proxmatch element in a search response represents a single search result (i.e. a POI result or a geocoded address result). A proxmatch element must contain a place element and may optionally contain a search-filter element, a premium-placement element, an enhanced-poi element, a poi-content element, and/or an unmappable element.

In accordance with the principles of the present invention, a place element in a proxmatch element contains location and/or POI data. A search-filter element in a proxmatch element contains additional search filter terms to add to a search query (if a user selects this item to expand). A premium-placement element in a proxmatch element indicates that the proxmatch element is a premium placement ad. An enhanced-poi element in a proxmatch element indicates that the proxmatch element is an enhanced POI. A poi-content element in a proxmatch element contains additional POI content, including advertisement-specific content. A poi-content element is included in a proxmatch element for premium placement ads and enhanced POIs. Premium-placement elements and enhanced-poi elements are empty.

A premium-placement pair element in a proxmatch element contains a key attribute and a value attribute. The following premium-placement pairs (e.g. premium-placement pairs supported by xAd) are valid for poi-content elements: an ad name premium-placement pair, a main text premium-placement pair, and a default user action premium-placement pair.

An ad name premium-placement pair contains key attribute, ‘ad-name’, and a value that specifies a name of an advertiser. A main text premium-placement pair contains key attribute, ‘main-text’, and a value that specifies a detailed description of an ad to be displayed on a detail screen. A default user action premium-placement pair contains key attribute, ‘default-user-action’, and a value that contains any one of the following acceptable variables: LANDING_PAGE, MAP, ROUTE, PHONE_CALL, or WEBURL.

An unmappable element (another empty element) is included in a proxmatch element when a place element in that proxmatch element does not refer to a physical location (i.e. a location unable to be navigated to or displayed on a map). When a place element is unmappable, an address stored in that place element may be partial/incomplete/empty. A point stored in an unmappable place element is ignored. In the current state of technology, only certain ads from Microsoft Bing are unmappable.

Every proxmatch element (POI and address) generated by the single search server 500 contains a distance attribute. A distance attribute represents a geographical distance between a location of a search result (i.e. a place element in a proxmatch element) and a current position of a client/user device.

In accordance with the principles of the present invention, the global single search system uses a spherical distance approximation to compute distance.

In accordance with the principles of the present invention, a search response may contain anywhere from 0 to n suggest-match elements. Suggest-match elements are included in a search response when the search-filter element in a corresponding search query contains result-style key, ‘suggest’.

A suggest-match element contains a search-filter element and a search suggestion for input text 810 entered in to the single search box global 110.

The search-filter element in a suggest-match element contains filter criteria for a single search. When a single search is initiated on a suggest-match element (i.e. when a suggestion item is selected from a list of suggestions 800 displayed on the single search client 550), the single search client 550 sends a search query to the single search server 500 containing the search-filter element stored in that selected suggest-match item.

A suggest-match element in a search response additionally contains the following attributes: line1 (a string), line2 (a string), and match-type (a string). The line1 attribute in a suggest-match element contains a first line of text to be displayed for that suggestion item. For POI suggestions, the line1 attribute contains a place name and for address suggestions, the line1 attribute contains address text (as formatted by the single search server 500). The line2 attribute in a suggest-match element (if present) contains a second line of text to be displayed for that suggestion item. For POI suggestions, the line2 attribute contains an address associated with a POI (pre-formatted as text by the single search server 500). Finally, the match-type attribute in a suggest-match element contains a result type (e.g. address result, POI result, etc.) for that suggestion item. The single search client 550 uses the match-type attribute in a suggest-match element to determine an appropriate icon to display for that suggestion. Potential match-type values include: POI, address, airport, gas, and category.

In accordance with the principles of the present invention, a search response includes anywhere from 0 to n file elements. A file element contains a file (potentially an image) associated with a returned proxmatch element (i.e. a POI match). A file image may be common to multiple proxmatch elements.

A search response includes a fuel-price-summary element when all search results returned in that search response are gas stations. A fuel-price-summary element is never present in a search response that contains suggest-match elements (i.e. suggestions).

In accordance with the principles of the present invention, a search response always contains an iter-result element. An iter-result element holds an iteration state for a search response.

The following depicts an exemplary search response template, in accordance with the principles of the present invention.

(search-reply ( )

(proxmatch (distance |Q52TvQ==|)

(place (name “Dairy Queen”)

(location (name “”)

(address (city “Aliso Viejo” country USA
airport “” county “” state CA
str “27782 Aliso Creek Rd” xstr “” sa “”
postal “92656” type street))
(point (lat |QEDHkT6BRQ8=| lon
|wF1uY51eSjg=|)))

(phone (country “1” kind primary number
“3620623” area “949”))
(category (code AEF name “”))
(category (code AEMH name “”)))

(poi-content (id “46167”)

(pair (value “1518” key brand-id))))

(iter-result (state “10”)

(exhausted)))

The following depicts an exemplary search response template for a search response with suggestions, in accordance with the principles of the present invention.

(search-reply ( )

(suggest-match (line1 “321 Hollywood Blvd. Hollywood, CA
92101”)

(search-filter ( )

(pair (value ″321 Hollywood Blvd. Hollywood, CA
92101″ keyname))
(pair (value ″main-screen″ key source))
(result-style (key geocode))))

(suggest-match (line1 “Hollywood Video” line2 “789 Aliso Creek
Rd. Aliso Viejo, CA 92656”)

(search-filter ( )

(pair (value ″Hollywood Video 789 Aliso Creek
Rd. Aliso Viejo, CA 92656″ key name))
(pair (value “dont_ worry_about_this_value″ key
“search-result-id”))
(pair (value ″main-screen″ key source))
(result-style (key single-search)))

(suggest-match (line1 “Planet Hollywood” line2 “123 Sunset
Blvd. Beverly Hills, CA 90210”)

(search-filter ( )

(pair (value ″Planet Hollywood 123 Sunset Blvd.
Beverly Hills, CA 90210″ key name))
(pair (value
“this_value_is_meaningless_to_client″ key
“search-result-id”))
(pair (value ″main-screen″ key source))
(result-style (key single-search))

Search results returned in a search response are displayed on a results screen 710 on the single search client 550. However, when a single search is initiated from the map screen 200, results are first presented on a map, along with an option to view results in list form. When a single search is initiated from the map screen, results are presented on a map even for suggested items expected to yield only one search result upon search.

Selection of a POI search result causes a standard POI detail screen for that selected POI item to be displayed on the single search client 550. A user can touch anywhere on a POI search result to invoke a corresponding detail screen.

A POI detail screen comprises the following attributes (when available): title (name of POI), address (street number, street address, city, state, zip code), approximate distance (from search center-point), directional heading (a compass ordinal), phone number, category(s), rating and rating count, hours of operation, picture, description, review count, additional properties (when available) (e.g. price, cuisine, parking options, hotel class, hotel rate, and amenities), and latitude and longitude.

In addition, attributes on a POI detail screen may be supervened by the following POI information (in the following order), when applicable: hours of operation, price, cuisines, description (customer message), special features, parking, attributes, and tips. Latitude and longitude are preferably the last two attributes displayed on a POI detail screen for a business.

Fetching and displaying a POI picture does not hold up display of a POI detail screen. POI data (including pictures), if already fetched, is held in a client-side cache, so that if at any point fetched POI data is subsequently requested, that POI data may be fetched from the cache. The client-side cache is preferably constrained by a pre-determined size limit.

Selection of a gas station/gas price search result causes a detail screen for that selected gas station/gas price item to be displayed on the single search client 550. A gas station/gas price detail screen contains the following data: gas station name, street address, city, state, ZIP, phone number, distance from center point of search, prices for each gasoline grade (when available), price for diesel (when available), price for ethanol (when available), and whether or not the gas station supports a charging station for electric vehicles (when available).

In addition to returning search results (POI results specifically) for a single search, the global single search system also returns advertisements. The global single search system supports an existing premium placement ad functionality. Ads are powered by an ad provider (e.g. xAd).

In accordance with the principles of the present invention, the single search server 500 returns a premium placement ad with each set of local search results returned to the single search client 550 (including any set of search results returned in response to a “More Results” request). Depending upon a particular embodiment, the single search server 500 may or may not retrieve premium placement ads for non-local searches, e.g., movie, event, traffic, weather, gas, and VZW store searches (the current implementation of the single search system bans ads from such searches). Premium placement ads are not returned with address results.

Existing premium placement ad functionality is extended within the present invention to support integration of an existing location based advertising platform (e.g. xAd). In accordance with the principles of the present invention, the global single search system uses a location based advertising platform to register and manage user identification and retrieve premium placement advertisement data. In particular, premium placement advertisement data is retrieved from a location based advertising platform server (e.g. xAd).

In accordance with the principles of the present invention, end user checking performed by an existing location based advertising platform API, retrieves advertisements that are targeted geographically and based on a user search query. For instance, the location based advertising platform ad server initially selects advertisement candidates based on location, and then further refines advertisement candidates using categories and/or keywords. For instance, after location is analyzed, a keyword parameter may be used to select an ad from a list of possible ad candidates. However, a keyword match does not always exist. In accordance with the principles of the present invention, even if no keyword match exists, an advertisement with matching location criteria is still returned to the single search client 550.

More specifically, the global single search system retrieves a premium placement ad from the existing location based advertising platform, by specifying the following targeting criteria: userID, location, search term (optional, used in search term targeting), and search category (optional, used in category targeting). Location targeting criteria is provided to the location based advertising platform as a lat/lon pair. If a location associated with a search query is “In My Location”, then location targeting criteria for that search query is a current location of a requesting client/user device.

The single search server uses an ad retrieval request to retrieve an ad from the location-based advertising platform. An ad retrieval request specifies a NIM category and a ‘what’ search term corresponding to a particular single search. If the integrated location based advertising platform returns no ad in response to an ad retrieval request, or if the location based advertising platform returns a vantage point ad only, then the single search server 500 does not return any ad to the single search client 550 and the single search client 550 displays local search results only.

Category targeting is used to retrieve advertisements relevant to a category selected from a list of categories on the single search client 550. Category targeting is performed when a category is selected to initiate a single search, and no search query is entered in to the single search box global 110 (e.g. category ‘Chinese Restaurants’ is selected from a category list on the single search client 550). In accordance with the principles of the present invention, the name of a category selected to initiate a single search is used to create a keyword parameter for advertisement retrieval. For instance, exemplary category targeting criteria used to select an advertisement relevant to selected category, ‘Restaurants’, includes the following: What=“ ” (i.e. no search query is entered in to the single search box global 110), Category=‘Restaurants’ (i.e. name of category selected to initiate a single search), and Keywords=‘Restaurants’ (i.e. keyword used for category targeting).

A keyword parameter may contain one or more words. All categories selected to initiate a single search are included in a keyword parameter. For example, if What=“ ” (i.e. no search query is entered in to the single search box global 110), and Category=“Gas” and “Automotive” (i.e. two categories selected), then Keywords=“Gas Automotive”. For this exemplary single search, the location based advertising platform returns ad targeting on “Gas”, “Automotive”, or “Gas Automotive”, and puts a higher preference on ads containing exact match, “Gas Automotive”. A keyword parameter is not used to retrieve ads when a single search is initiated on ‘All Categories’ and a search query is not entered in to the single search box global 110. For example, if What=“ ” (i.e. no search query is entered in to the single search box global 110) and Category=“All Categories”, then Keywords=“ ”, indicating that a keyword parameter is not part of the end user checking process used to retrieve an advertisement for this single search.

The location based advertising platform (e.g. xAd) supported within the present invention preferably accepts all keyword parameters and attempts to select advertisements relevant to a user search query. If a single search is initiated via a search query (i.e. a ‘What’ field) only, then that search query is used to construct a keyword parameter for advertisement retrieval. For example, if What=‘Burger King’ and Category=‘All Categories’, then Keywords=‘Burger King’.

A keyword parameter may contain multiple keyword phrases, separated by commas (,). Multiple keyword support allows a single search to be initiated on a POI category and a search query. The location-based advertising platform server supported within the present invention preferably uses all phrases in a keyword parameter to search for a matching advertisement. For example, if Category=“Gas”, and What=“Shell”, then Keywords=“Gas, Shell” (i.e a keyword parameter based on selected category and search term, category and search term being separated with a comma).

In accordance with the principles of the present invention, the global single search system also takes advantage of category and brand information in search results to obtain advertisements. In particular, the global single search system may consider category information to select an advertisement when a result candidate maps directly to a POI stored under a particular POI category name. For instance, if search query, ‘Coco's’ is entered in the single search box global 110, and result candidates include search result, ‘Coco's Restaurant’, a search result for a POI stored in POI category, ‘American Restaurants’, then POI category, ‘American Restaurants’, may be used as category targeting criteria to select an advertisement to return with search results.

Similarly, the global single search system uses brand information to select an advertisement when a result candidate maps directly to a particular brand name stored in the brand data set. For example, if search query, ‘McDonald's, is entered in to the single search box global 110, and result candidates include search result, ‘McDonald's’, a search result for a POI stored in the brand data set, then POI brand, McDonald's, may be used to return relevant advertisements to the single search client 550. The global single search system also takes advantage of category and brand information in search results to obtain related sponsored ads. For instance, when search query, ‘McDonald's’ is entered in to the single search box global 110, the single search server 500 preferably returns a premium ad for ‘In-N-Out Burger’ (i.e. a related sponsored ad).

In accordance with the principles of the present invention, the single search server 500 returns one advertisement for each set of local search results returned to the single search client 550. In particular, the single search server 500 performs POI search and ad retrieval concurrently and returns combined results (POI and ad results) to the single search client 550. A wait threshold for a premium placement ad is 1 second. If the ad server takes longer than 1 second to return an ad, then the ad is not returned with search results.

In accordance with the principles of the present invention, an advertisement returned to the single search client 550 contains ad details and storefront details (e.g., storefront location (lat/lon), name, and address). In particular, each premium placement ad retrieved from the location based advertising platform comprises the following data: ad name, intro text, intro icon, main text, ad storefront (if multiple storefronts apply, then only the first storefront is returned in an advertisement), and lat/lon. Premium placement ads do not need to include a lat/lon. For example, an advertisement for DirecTV in the USA does not need to provide a location. Instead, a phone number or a web link may be provided. Details displayed for each ad storefront include: name, address, and phone number. If an override phone number is available for a premium placement ad, then that override phone number is returned to the single search client 550 instead of the storefront phone number. Hours of operation are not displayed for a premium placement ad. A premium placement ad does not contain a distance value.

In a results set, a premium placement ad displays an advertiser's name on a first line of display and a storefront address on a second line of display. An intro icon and additional text displayed for a premium placement ad are not separated by vertical lines on a results screen 710. Moreover, a premium placement ad is preferably displayed with a yellow background.

A premium placement ad is preferably positioned at an indexed location in a results set returned to the single search client 550, and displayed (by default) at this indexed location on a results screen 710. For example, a premium placement ad may be returned as a first item in a results set sent to the single search client 550, and subsequently displayed (by default) as the first item on a results screen 710.

A premium placement ad is displayed using an intro icon when returned with local search results displayed (as pins) on a map. Selection of a premium placement ad on a map causes intro text and an instructional phrase (e.g. “Click for more details”) for that ad to be displayed in a balloon on the map. For example, a name of a location and an identifying phrase (e.g. “Sponsored AD”) may be displayed in a balloon on a map to represent a premium placement ad. Selection of a balloon representing a premium placement ad causes a POI detail screen for that selected ad to be displayed on the single search client 550.

Registered users may interact with advertisements displayed on a results screen 710. In particular, if an ad is selected on a results screen 710, then a POI detail screen for that selected ad is displayed on the single search client 550. Any option (e.g. navigate, map, add to favorites, share, call, or search) displayed on the POI detail screen for a selected ad may be selected to prompt the single search client 550 to perform that action.

The global single search system collects and stores analytic data so that mobile application usage may be profiled. In accordance with the principles of the present invention, the global single search system uses the location based advertising platform to track impressions and interactions of users with premium placement ads.

In particular, the single search server 500 uses the existing location based advertising platform to register and manage user identification. In particular, an ILAP userID is stored on the single search client 550 and the single search server 500. If an ILAP userID is not present on the single search client 550, then the single search client 550 requests a userID from the single search server 500. If a userID is not present on the single search server 500, then the single search server 500 requests a new userID from the location based advertising platform (e.g. xAd).

Prerequisites required to enable a successful local search request and download with advertisements, include: a network to allow the single search client 550 to communicate with the single search server 500 (to download search results and deliver analytics), relevant POI data stored on the single search server 500, and an affiliate account setup between the single search server 500 and an existing location based advertising platform. Once prerequisites are fulfilled, the single search server 500 may retrieve 10 search results from Apache Solr™ 560 and 1 premium advertisement from the location based advertising platform server for each single search initiated on the single search client 550. Search results and an advertisement are returned to the single search client 550 in a search response (a premium ad is preferably the first result returned in a search response). In accordance with the principles of the present invention, results are packaged by the single search server 500 so that the single search client 550 does not have to do any sorting. The single search server 500 downloads a new ad server whenever more search results are requested for identical search criteria.

If results retrieved for a search query contain only premium placement ads, then the single search server 500 does not return any data to the single search client 550, and the single search client 550 displays an informational message (e.g. ‘NO RESULTS FOUND’) to this accord. Similarly, if results retrieved for a search query contain no premium placement ads, then only POI search results are returned to the single search client 550.

In accordance with the principles of the present invention, the global single search system supports a conventional find a place feature and a conventional enter an address feature. These conventional features (i.e. the find a place feature and the enter an address feature) are supported within the present invention, in addition to the single search feature, since current subscribers typically expect these features, a portion of users prefer a path driven user interface, and a portion of users like the category browsing capability offered on the existing find a place screen 400.

The find a place screen 400 supported within the present invention encompasses a single search box global 110, as opposed to a conventional search box, and supports search suggestions and a category list 410. However, the category list 410 on the find a place screen 400 does not serve as a filter. Instead, selection of a category is treated as a distinct operation of search using a search term.

When the global single search system is accessed from the find a place screen 400, a hint is sent to the global single search system, informing the system to accord a higher relevance score to POI results. Requirements for POI results returned in response to a search initiated from the find a place screen 400 are the same as requirements for POI results previously described herein.

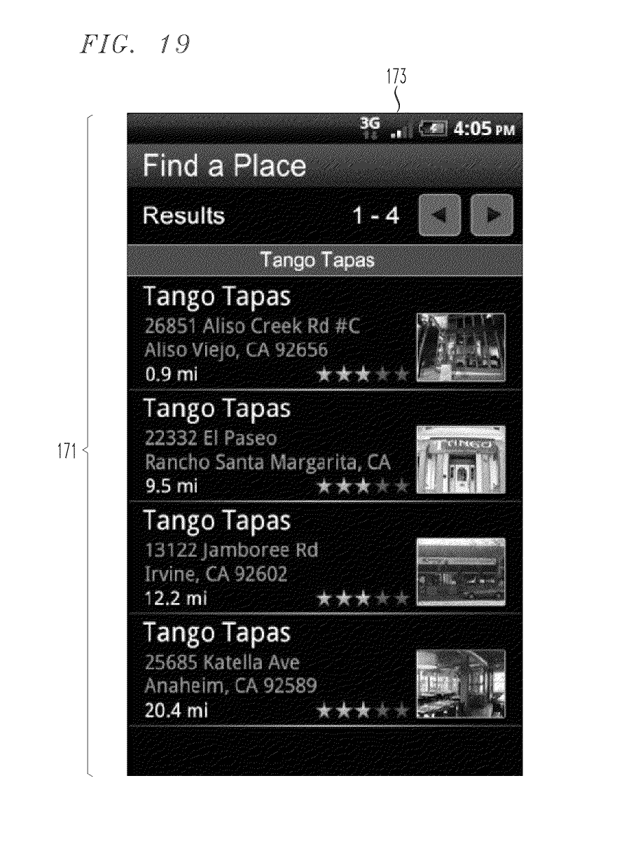

FIG. 19 depicts an exemplary find a place results screen, in accordance with the principles of the present invention.

As depicted in FIG. 19, a list of business locations 171 is displayed on a find a place results screen 173 in response to a conventional find a place request.

The enter an address screen 300 supported within the present invention encompasses a single search box global 110, as opposed to a conventional search box, and supports search suggestions. Address search results and address details retrieved for an enter an address request are geo-coded.

When the global single search system is accessed from the enter an address screen 300, a hint is sent to the global single search system, informing the system to accord a higher relevance score to address results. Requirements for address results returned in response to a search initiated from the enter an address screen 300 are the same as requirements for address results previously described herein.

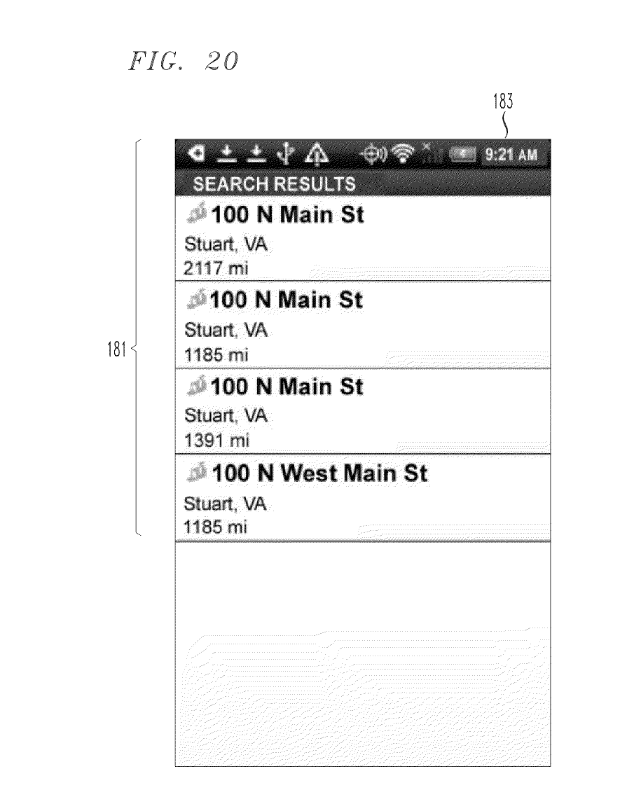

FIG. 20 depicts an exemplary enter an address results screen, in accordance with the principles of the present invention.

As depicted in FIG. 20, a list of addresses 181 is displayed on an enter an address results screen 183 in response to a conventional enter an address request.

The enter an address screen 300 automatically sets focus inside the single search box global 110 when a keyboard 310 is launched. When the microphone button positioned next to the single search box global 110 on the find an address screen is selected, text is automatically returned by the automatic speech recognition (ASR) server and searched.

In particular, if focus (a cursor 910) is inside the single search box global 110 (meaning that either a user has pressed the single search box global 110 or focus has been placed inside the single search box global 110 automatically) and an ASR button (i.e. a microphone button) positioned next to the single search box global 110 is selected, then the global single search system requests a verbal search query and automatically initiates a single search on that verbal search query. An appropriate next screen (e.g. a search results list or details screen) containing relevant search results is subsequently displayed.

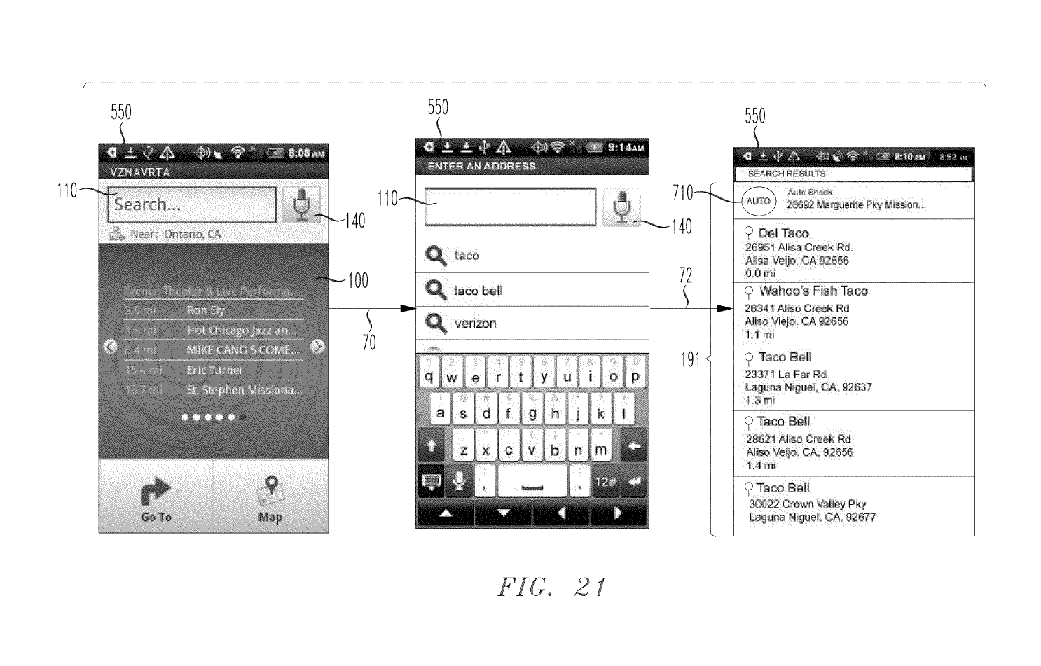

FIG. 21 portrays a call flow depicting an exemplary single search via automatic speech recognition (ASR), in accordance with the principles of the present invention.

In particular, a main screen (in carousel view) 100 is initially displayed on the single search client 550. As shown in step 70, focus is placed inside the single search box global 110 (automatically or as a result of a user pressing inside the single search box global 110). The ASR button 140 is pressed while focus is set inside the single search box global 110, and a user speaks in to a microphone on a client/user device. User input is treated as a verbal search request and a results screen 710 containing relevant search results 191 is automatically displayed on the single search client 550, as depicted in step 72.

Certain screens do not automatically set focus inside the single search box global 110. On such screens, if focus is set inside the single search box global 110 and an ASR button (i.e. a microphone button) positioned next to the single search box global 110 is pressed, then text is returned by the automatic speech recognition (ASR) server and automatically searched. In most cases, search via automatic speech recognition (ASR) returns a search results list or a detail screen.

The present invention also supports a conventional airports feature and a conventional recent searches feature.

In accordance with the principles of the present invention, the global single search system generates reports that detail search query counts and result relevancy. For instance, the global single search system generates the following search query reports on a periodic basis: number of search requests report, top 1000 POI search terms report, and top 20 search categories report. Additional reports include: number of requests classified as a POI search request report, number of requests classified as an address search request report, and number of requests that include a special instruction term (e.g. ‘Go’) in the search query report. Moreover, the number of requests classified as a POI search request report is broken down in to the following reports: number of requests classified as a category search report, number of requests classified as a gas search report, number of requests classified as a VZW store search report, number of requests classified as an along-my-route search report, and number of requests where location is set to ‘current location’ report.

The global single search system also generates result relevancy reports. Result relevancy reports contain a number of requests performed for each of the following calls to action: navigate, map, share, call, and find nearby. The global single search system uses result relevancy reports to judge the relevancy of search results returned to the single search client 550. Data accumulated in reports generated by the global single search system may be broken down according to the following: start date/end date, day part (hour of day), device platform, device model, and product version (client and web companion).

Top searches identified in reports are boosted as landmarks.

The present invention introduces a new search capability. A search-capability describes a search technology used, as well as an accompanying premium placement vendor. Clients use this search-capability to indicate vendors supported on the client. Servers use the search-capability to make sure that only supported vendors are returned to a client.

The single search server 500 provides a method of clustering and/or high availability. In particular, the global single search system is architected to be available 99.999% of the time.

For search queries processed by the single search server 500, an average server-side result generation wait_time of less than or equal to 750 milliseconds is preferably maintained, and a 95^{th} percentile wait_time of less than 2000 milliseconds is preferably maintained, per monitoring database table, tps_servlet_reply_event.

Moreover, for suggestion queries processed by the single search server 500, an average server-side result generation wait_time of less than or equal to 250 milliseconds is preferably maintained, and a 95^{th} percentile wait_time of less than 750 milliseconds is preferably maintained, per monitoring database table, tps_servlet_reply_event.

Search suggestions sourced from client side data are preferably available in under a predetermined number of milliseconds.

If the single search server 500 is restarted for any reason, a cache warm-up mechanism is employed. The present invention is capable of supporting 25 search queries and 100 suggestion queries per second, as measured by standard load test tools.

Several load impacting changes are implemented within the present invention. Notably, the global single search system fetches advertisements via a remote service independent of a query search system, which places a potential negative impact on POI search performance. Further, along-my-route searches, gas price searches, and freeform geocode queries are proxied through the search servlet 510, which potentially impacts system performance (along-my-route searches and gas price searches do not incur much processing overhead in search). System performance may be further impacted as a result of additional load incurred by geocode, due to false positives returned for searches incorrectly categorized as address searches.

The global single search system improves user experience through improved search categorization, dynamic feedback, and a substantial performance boost over the existing searchbuilder system 540.

Several considerations and constraints are placed on the suggestion functionality introduced within the present invention. In particular, the global single search system requires that suggestion content never be blocked based on assumptions built upon partial input. For instance, though a query for ‘pizza’ may seem like a request for a pizza restaurant category, it is possible that ‘pizza’ is just an in-progress substring of some superset of user input. Hence, the global single search system does not block suggestions based on partial query strings (e.g. ‘pizza’). For example, in exemplary search query ‘pizzaros magic palace’, category name ‘pizza’ is just a small substring of user input.

Moreover, remote calls made by the search servlet 510 impact the performance of the suggestion functionality. Hence, a no inter-servlet query constraint is placed on the suggestion functionality to assure that suggestions are especially responsive to a requesting client/user device. Also, being that suggestions need not contain full detailed information, information available to the search servlet 510 is sufficient for fulfilling suggestion queries.

The global single search system also applies the theory: ‘good enough really is’ to the inventive suggestion functionality. Being that suggestions cover a wide swath of data based on partial input, the present inventors identify no need to pre-fetch additional information when suggestion line1 and/or line2 need not be filled.

The suggestion functionality is also required to provide and use ‘shortcuts’. In accordance with the principles of the present invention, a suggest-match element contains a search filter that is echoed back to the search servlet 510 once a suggestion is selected. As new data corpora are added to the global single search system, shortcuts enabled by the suggestion system provide a performance boost for an actual search on a suggestion item, should that suggestion item be selected. For example, the global single search system provides a geocode result_style element in a suggestion for a street name, so that the single search server 500 may skip filter logic and a remote call to Apache Solr™ 560, whenever that street suggestion is selected.

The suggestion functionality is also required to keep suggestion line1 and line2 generic/freeform. In accordance with the principles of the present invention, to keep the suggestion system flexible, the global single search system disallows a client to make assumptions based on text displayed in suggestion line1/line2. A flexible suggestion system makes backward and forward compatibility easier to maintain.

The single search server 500 provides quick recovery via a reinstall of data or backup/restore. If a reinstall takes too long, then a rotating snapshot method is preferred (for systems that are constantly changing, e.g., feeds). Quick recovery is necessary in the event of data corruption. The single search server 500 additionally provides a method for quick upgrades and rollback.

In accordance with the principles of the present invention, the single search server 500 provides a method of system monitoring. In particular, a simple network management protocol (SNMP) and a Java management extensions system (JMX) are available for detailed information gathering. The monitoring method used within the present invention includes any network ports that require availability for proper system functionality (admin ports need not be monitored, nor do unused supplemental ports/services), and any other critical services that software depends on. The monitoring method supported within the present invention includes the following metrics: gauge system health (such as transactions per second), query latency, java heap usage, cache misses, error counters, etc. Once metrics are understood, thresholds are established for of warning and critical levels. A method of tracking software error logs is also desired. In most cases, tracking of software errors is achieved via syslog. Software errors are typically tracked using a standard syslog mechanism.

Existing monitoring database table, search-events, is used to log/report data within the global single search system. In accordance with the principles of the present invention, the following fields are added to existing monitoring database table, search_events: Apache Solr™_wait_time, uber_wait_time, uber_result_used, proxpoi_wait_time, geocode_wait_time, geocode_result_count, search_lat, search_lon, and result_types.

In particular, field Apache Solr™_wait_time is added to existing monitoring database table, search-events, to represent how long the search servlet 510 has blocked while waiting for Apache Solr™ 560. Apache Solr™_wait_time uses the same units/types as conventional wait_time fields maintained within existing monitoring database table, search_events. Moreover, field uber_wait_time is added to existing monitoring database table, search_events, to represent how long the search servlet 510 spent in uber lookups. Uber_result_used is a text field used to hold a city/state/zip combination chosen from uber results. In accordance with the principles of the present invention, field proxpoi_wait_time holds the amount of time the search servlet 510 waited for proxpoi servlet 520 calls. Field geocode_wait_time holds the amount of time the search servlet 510 waited for geocode lookups. Field geocode_result_count holds the number of results returned from the geocode servlet 530. Fields search_lat and search Ion hold a search center used to conduct a search when a current location of a client/user device is not used for search. Further, field result_types holds a numerical value associated with a bit representation of result types returned to the single search client 550. Each numerical value is equal to 2 raised to the power of the bit position (e.g. 2̂0=1, 2̂1=2, . . . , 2̂7=128). Field result_types preferably uses the following numeric representation: 1=suggestion(s); 2=POI; 4=non-local landmark; 8=StreetAddress; 16=city+state+zip; 32=airport; 64=gas; and 128=VZW stores.

For example, a suggestion response including POI suggestions and one state-only suggestion, results in a result_types value of 19 (1 (suggestions)+2 (POI)+16 (city+state+zip)=19). Moreover, a search response comprising POI search results and one state-only search result (a result response identical to the previous exemplary response, minus result_style=‘suggest’), results in a result_types value of 18 (2 (POI)+16 (city+state+zip)=18).

Since POI data is sourced from multiple vendors, the present invention minimizes the occurrence of duplicate POIs by way of a de-duplication mechanism. The de-duplication mechanism used within the present invention combines (according to Sinsearch-5.3) records that contain an identical latitude, longitude, and POI name, and additionally combines (according to Sinsearch-5.3) records that contain an identical POI name, street number, street address (street1) and postal data.

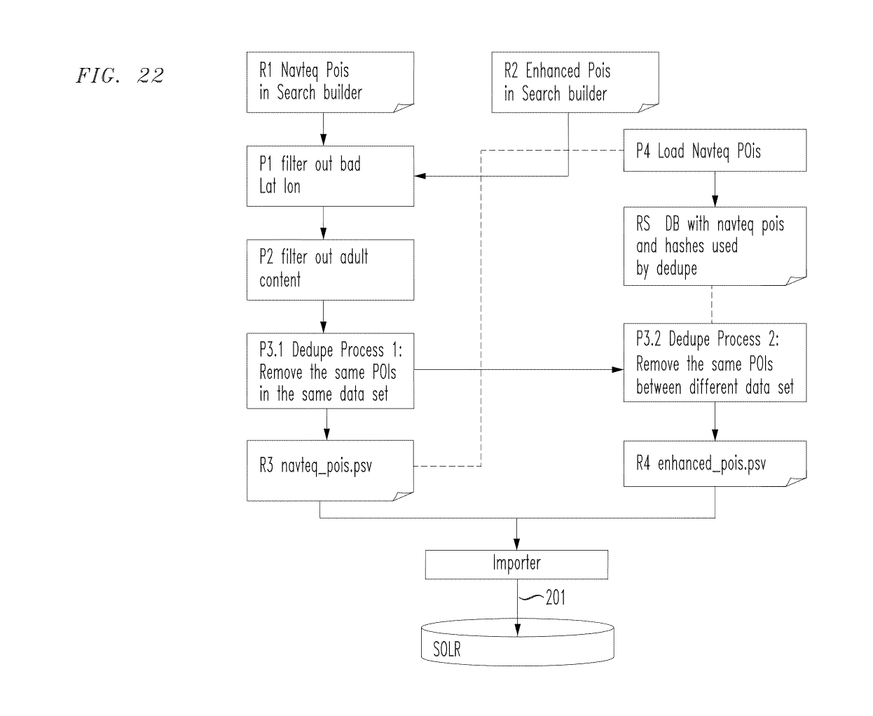

FIG. 22 depicts an exemplary de-duplication mechanism used to remove duplicate POIs from source data, in accordance with the principles of the present invention.

As depicted in steps R1 and R2 of FIG. 22, POI data is first queried from searchbuilder (oracle) 540 and dumped to pipe-delimited flat files (i.e. data undergoes a dumping process). Data files are then processed by a data preprocess (p1, p2 and p3). During a data preprocess (steps P1, P2, P3), POI data is passed through an adult content filter P2 and a bad lat Ion filter P1, and subsequently processed by a dedupe process P3. The present invention uses an sqlite based dataset (e.g. ReadOnlySqliteDataSet) to save and index POIs when deduping Navteq and CitySearch data. As depicted in step 201, POI data is imported to Apache Solr™ 560 following completion of a data preprocess.

The system architecture of the global single search system is preferably based on a conventional NAVbuilder Server client/server framework that uses python servlets (i.e. server-side programs that receive and respond to requests from users) to handle requests from a remote client application.

An existing web companion is enhanced to incorporate use of the global single search system.

Existing ‘Maps’ and ‘Local Search’ tabs are unified into a single ‘Maps’ tab in the present invention. The ‘Maps’ tab incorporates a single search box global 110. Search suggestions are supported by the single search box global 110 on the ‘Maps’ tab.

In accordance with the principles of the present invention, the single search server 500 is developed such that it is agnostic to the client device platform. The present invention provides support for several device platforms (e.g. android, RIM, iPhone, Brew platforms, BB10, and Windows Phone 8). The global single search system preferably supports preferably supports the Android device platform, and all markets where Blackberry devices are commercially available.

The system of context/filter is general purpose enough to be used in a wide array of freeform, natural language queries, and may additionally be applied to new data corpuses as they become available.

The present invention has particular applicability to location-based services, mobile search services and navigation services, e.g., as provided by maps.google.com and navteq.com.

The present invention pertains to POI and address searches initiated from a single search box global 110 (i.e. a text input field). Meta-data concerning a nature of a search is not provided to the global single search system.

The diagrams included herein are meant for illustrative purposes only.

While the invention has been described with reference to the exemplary embodiments thereof, those skilled in the art will be able to make various modifications to the described embodiments of the invention without departing from the true spirit and scope of the invention.

What is claimed is:

1. A global single search system that filters search query data for context and user intent within a location based search engine, comprising:
a single search box global to accept user search query data;
a single search client to display search results for said user search query data; and
a search servlet to filter and boost said user search query data and return relevant search results for said user search query data .

2. The global single search system that filters search query data for context and user intent within a location-based search engine according to claim 1, wherein:
said global single search system supports a global market.

3. The global single search system that filters search query data for context and user intent within a location based search engine according to claim 1, wherein:
said single search box global is a standalone text input field.

4. The global single search system that filters search query data for context and user intent within a location based search engine according to claim 1, wherein:
said single search box global is unpaired with a ‘where’ field.

5. The global single search system that filters search query data for context and user intent within a location based search engine according to claim 1, wherein:
said single search box global does not require meta-data identifying a search type.

6. The global single search system that filters search query data for context and user intent within a location based search engine according to claim 1, wherein:
said user search query data is a point of interest (POI) search query.

7. The global single search system that filters search query data for context and user intent within a location based search engine according to claim 1, wherein:
said user search query data is an address search query.

8. The global single search system that filters search query data for context and user intent within a location based search engine according to claim 1, wherein:
said single search box global is accessible on said single search client.

9. The global single search system that filters search query data for context and user intent within a location based search engine according to claim 1, wherein:
said single search client searches locally for matches to client-side data.

10. The global single search system that filters search query data for context and user intent within a location based search engine according to claim 1, wherein:
said single search client forwards said search query data to said search servlet for relevant search results.

11. The global single search system that filters search query data for context and user intent within a location based search engine according to claim 1, wherein:
said search servlet employs a series of filter methods to progressively extract specific aspects of user intent and context from said user search query data.

12. The global single search system that filters search query data for context and user intent within a location based search engine according to claim 11, wherein:
said search servlet determines a data corpus to search for relevant search results based on said user intent and context extracted from said user search query data.

13. The global single search system that filters search query data for context and user intent within a location based search engine according to claim 1, wherein:
said search servlet interfaces with an Apache Solr™ search engine to retrieve said search results for said user search query data based on said specific aspects of context and user intent extracted from said user search query data.

14. The global single search system that filters search query data for context and user intent within a location based search engine according to claim 1, wherein:
said search servlet interfaces with an advertisement provider to return an advertisement with each set of local search results returned for said user search query data.

15. The global single search system that filters search query data for context and user intent within a location based search engine according to claim 1, wherein:
said search results are ordered and returned to said single search client based on location criteria and relevance criteria.

16. The global single search system that filters search query data for context and user intent within a location based search engine according to claim 14, wherein said relevance criteria comprises:
relevance data sets.

17. A method of providing search suggestions to a single search client as text is input, character by character, into a single search box global, comprising:
querying a single search server for search suggestions based on said input text;
comparing said input text to each data source part of each searchable data corpus;
determining if said input text matches a start of a word of any one or more available data source item;
determining a relevance order for said one or more matching data source items when said start of said word of any one or more available data source items matches said input text;
returning said one or more matching data source items to said single search client in a suggestions list; and
refining suggestion candidates as additional characters are entered into said single search box global.

18. The method of providing search suggestions to a single search client as text is input, character by character, into a single search box global according to claim 16, wherein:
said one or more matching data source items are returned in order of relevancy.

19. The method of providing one or more search suggestions to a single search client as text is input, character by character, into a single search box global, according to claim 16, wherein:
awarding a higher relevance score to said one or more matching data source items that are geographically closer to a requesting client/user device.

20. The method of providing one or more search suggestions to a single search client as text is input, character by character, into a single search box global, according to claim 16, wherein:
said one or more search suggestions are point of interest (POI) suggestions.

21. The method of providing one or more search suggestions to a single search client as text is input, character by character, into a single search box global, according to claim 16, wherein:
said one or more search suggestions are address suggestions.

22. The method of providing one or more search suggestions to a single search client as text is input, character by character, into a single search box global, according to claim 16, wherein:
said one or more search suggestions are airport suggestions.

23. The method of providing one or more search suggestions to a single search client as text is input, character by character, into a single search box global, according to claim 16, wherein:
said one or more search suggestions are point of interest (POI) category suggestions.
